(19) United States
(12) Patent Application Publication
(10) Pub. No.: US 2025/0202767 A1
(43) Pub. Date: Jun. 19, 2025

(54) DYNAMICALLY CONFIGURABLE NETWORK ARCHITECTURE AND METHODS

(71) Applicant: DMG Blockchain Solutions Inc., Delta (CA)

(72) Inventors: Daniel Marks, Durham, NC (US); Joshua Metnick, Chicago, IL (US); David Steinberg, Chicago, IL (US); Gert-Jaap Glasbergen, Voorschoten (NL)

(21) Appl. No.: 19/055,408

(22) Filed: Feb. 17, 2025

Related U.S. Application Data
(63) Continuation of application No. PCT/US2023/029874, filed on Aug. 9, 2023.
(60) Provisional application No. 63/398,301, filed on Aug. 16, 2022.

(51) Int. Cl. H04L 41/0813; H04L 41/0893

(52) U.S. Cl. CPC H04L 41/0813; H04L 41/0893

(57) ABSTRACT

Machines and articles, processes for using the machines and articles, processes for making the machines and articles, and products produced by the processes of making, along with necessary intermediates, involving aspects of a dynamically configurable network architecture.

### CROSS-REFERENCE TO RELATED APPLICATION(S)

This application claims priority to, and is a continuation of, PCT international application number PCT/US2023/029874, filed on Aug. 9, 2023, incorporated herein by reference in its entirety, which claims priority to, and the benefit of U.S. provisional patent application Ser. No. 63/398,301, filed on Aug. 16, 2022, incorporated herein by reference in its entirety. Priority is claimed to each of the foregoing applications.

### BACKGROUND

Network architecture refers to the design of a computer network. It is the framework for the specification of a network's physical components and their functional organization and configuration, its operational principles and procedures, as well as communication protocols used. Two of the most widely used types of network architecture are peer-to-peer and client/server.

Client/server architecture is also called ‘tiered’ because it uses multiple levels, typically to reduce design complexity, with each layer offering services to the higher layers. For example, a typical OSI (open system interconnection) model includes:

| Layer | Name | Example Protocols |
|---|---|---|
| 1. | Physical Layer | Ethernet, USB, Bluetooth, IEEE902.11 |
| 2. | Data Link Layer | PPP, ATM, Ethernet |
| 3. | Network Layer | IP, ARP, ICMP, IPSec |
| 4. | Transport Layer | TCP, UDP |
| 5. | Session Layer | NetBios, PPTP |
| 6. | Presentation Layer | SSL, TLS |
| 7. | Application Layer | HTTP, FTP, DNS, SNMP, Telnet |

With respect to reconfigurable network architecture, attention is respectfully drawn to U.S. Pat. No. 11,245,619B1, titled “Dynamic fabric system,” which states “Directed to dynamic fabric systems and methods are disclosed for providing connections between endpoints of a communication network. An exemplary dynamic fabric system can include backplane lanes, a dynamic fabric device, and a control device. The dynamic fabric device can include local fabric lanes and a network interface device configurable to communicatively connect the local fabric lanes to a network. The dynamic fabric device can also include a local switch configurable forward messages to backplane lanes and an interconnect configurable to statically connect local fabric lanes and corresponding backplane lanes. The dynamic fabric device can also include a controller configurable to create or break these static connections. The control device can provide instructions to the dynamic fabric device to create or break the static connections based on changes in the number of active dynamic fabric devices installed in the dynamic fabric system.”

See also U.S. Pat. No. 11,051,183B2, titled “Service provision steps using slices and associated definitions” and which refers to “A system for managing a network comprising an Operator Domain. The system comprises a hierarchical system of management functions; and a respective service catalogue associated with each management function. The service catalogue storing information of services that can be provided by the management function to at least one higher level management function.”

Note as well U.S. Pat. No. 11,050,626B2, titled “Service provision for offering network slices to a customer” which discloses “A system for managing a network comprising at least one network slice instance including at least one network slice subnet instance. The system comprises a network slice management function associated with each network slice instance, the network slice management function configured to expose one or more management functions to a customer such that the customer can effect limited management of its associated network slice instance; and a network slice subnet management function associated with each network slice subnet instance, the network slice management function configured to expose one or more management functions to a customer such that the customer can effect limited management of its associated network slice subnet instance.”

Further, note “Pool Detective”, last accessed on the Internet on Aug. 4, 2022, including MIT's press release (By Gert-Jaap Glasbergen and Neha Narula) dci.mit.edu/research/2020/8/21/pool-detective-lead-gert-jaap-released-a-new-research-description-for-pool-detective-who-is-monitoring-mining-pools and github.com/mit-dci/pooldetective and medium.com/mit-media-lab-digital-currency-initiative/who-is-monitoring-mining-pools-65de79b90710 “In order to address the risk that mining pool operators could go rogue, DCI developed Pool Detective. The idea is simple: We join all the public mining pools and monitor what they're doing, making sure it matches the work we′d expect to see. We add a proxy server between our own mining hardware and each mining pool in order to archive the jobs the mining pool instructs our hardware to perform, and the work we produced in return.” Additionally, note gertjaap.org/portfolio/dci-pooldetective/“That's why I started working on a project called PoolDetective for the DCI in the summer of 2019. The idea is quite simple: we position ourselves between the mining hardware and the mining pool(s), and we archive all communication that happens between the two. We archive the jobs the mining pool instructs our hardware to perform, and the work we produced in return.” Yet in addition, note dci.mit.edu/research/2020/6/19/bitcoin-magazine-netherlands-podcast-gert-jaap-glasbergen-was-interview-on-the-new-security-project-pool-detective.

Nonetheless, a need exists for other or better alternatives for computer network architectures and methods of computing.

### SUMMARY

This Summary is provided to introduce the idea herein that a selection of concepts is presented in a simplified form as further described below. This Summary and the following Overview are not intended to identify key features or essential features of subject matter, nor are the Summary and Overview intended to be used to limit the scope of claimed subject matter. Nothing herein is intended to serve as an admission of prior art, as the comments are present and informal understandings. Additional aspects, features, and/or advantages of examples will be indicated in part in the description which follows and, in part, will be apparent from the description, or may be learned by practice of the disclosure.

The following description of modes, the drawings, and the Summary are illustrative and are not to be construed as limiting. Numerous specific details are described to provide a thorough understanding of the disclosure. However, in certain instances, well-known or conventional details are not described to avoid obscuring the description. References to one or an embodiment in the disclosure can be, but not necessarily are, references to the same embodiment; and, such references mean at least one of the embodiments.

Reference in this specification to “one embodiment” or “an embodiment” means that a feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

With the foregoing in mind, consider apparatuses and articles of manufacture, processes for using the apparatuses and articles, processes for making the apparatuses and articles, and products produced by the processes of making, along with necessary intermediates, in the context that some, but not all, embodiments concern, in whole or part, relating to a dynamically configurable/reconfigurable computer network architecture.

In that context, in another one way of thinking, there can but need not necessarily be or entirely be, a dynamically configurable network architecture apparatus. The apparatus in whole or part can, but need not always, comprise a director computer configured to: communicate via Y worker computer connections, such that Y≥2, to two or more worker computers, with at least one worker computer connection to each worker computer; communicate via X assignment computer connections, such that X≥Y+2, to a group of one or more assignment computers; communicate such that for each instruction received from each said assignment computer connection, the instruction including a specification of a set of elements to be tested to determine whether any element of the set satisfies a condition: assign the instruction to one said worker computer connection; send the instruction to the one said worker computer connection; and if a response is received from the one said worker computer connection, the response including identification, if any, of the elements specified in the instruction that satisfies the condition, then send the response to the assignment computer connection from which the instruction was received; and if the response is not received from the one said worker computer connection, then indicate to the assignment computer connection from which the instruction was received that no response was received.

From another perspective, in yet another one way of thinking, there can but need not necessarily be or entirely be, method such as a method of making, e.g., a network architecture. The method or process may in whole or part, comprise: configuring a network architecture, including: interconnecting a director computer to communicate via Y worker computer connections, such that Y≥2, to two or more worker computers, with at least one worker computer connection to each worker computer; interconnecting the director computer to communicate via X assignment computer connections, such that X≥Y+2, to a group of one or more assignment computers; configuring the director computer to communicate such that for each instruction received from each said assignment computer connection, the instruction including a specification of a set of elements to be tested to determine whether any element of the set satisfies a condition, the director computer: assigns the instruction to one said worker computer connection; sends the instruction to the one said worker computer connection; and if a response is received by the director computer from the one said worker computer connection, the response including identification, if any, of the elements specified in the instruction that satisfies the condition, then the director computer sends the response to the assignment computer connection from which the instruction was received; and if the response is not received by the director computer from the one said worker computer connection, then by the director computer indicates to the assignment computer connection from which the instruction was received that no response was received.

Again, In that context, in yet another yet another way of thinking, there can, but need not always, be a method or process of using, e.g., a network architecture that is dynamically configurable. The method may, in whole or part comprise: communicating, by a director computer via Y worker computer connections, such that Y≥2, to two or more worker computers, with at least one worker computer connection to each worker computer; communicating, by the director computer via X assignment computer connections, such that X≥Y+2, to a group of one or more assignment computers; communicating, by the director computer such that for each instruction received from each said assignment computer connection, the instruction including a specification of a set of elements to be tested to determine whether any element of the set satisfies a condition, including: assigning the instruction to one said worker computer connection; sending the instruction to the one said worker computer connection; and if a response is received from the one said worker computer connection, the response including identification, if any, of the elements specified in the instruction that satisfies the condition, then sending the response to the assignment computer connection from which the instruction was received; and if the response is not received from the one said worker computer connection, then indicating to the assignment computer connection from which the instruction was received that no response was received.

### INDUSTRIAL APPLICABILITY

Industrial applicability is representatively directed to that of apparatuses and devices, articles of manufacture, and processes of making and using them as disclosed herein. Industrial applicability also includes industries engaged in such as one or more of computer science and electrical engineering, field programmable gate arrays, application specific integrated circuits, cryptography, cryptocurrency mining, central processing units, simulations, memory such as random access memory, nonvolatile memory, and rotating media storage or solid state flash memory storage, networking, communications and/or telecommunications, and computing systems, e.g., those involving networking and networking architecture, with or without a director computer, e.g., as in layers, as well as industries operating in cooperation therewith, depending on the implementation.

### BRIEF DESCRIPTION OF THE DRAWINGS

FIG. 1 is an illustration of an embodiment of flow of a network architecture.

FIG. 2 is an illustration of an embodiment in which additional director computers are organized into Z interposing layers to distribute instructions from assignment computers to worker computers.

FIG. 3 is an illustration of a second director computer interposed at a layer.

FIG. 4 is an illustration of a second director computer interposed at a layer that divides an instruction.

FIG. 5 is an illustration of an embodiment in which a first director computer selects one of two or more redundant director computers interposed at one said layer to send an instruction to.

FIG. 6 is an illustration of an embodiment in which the director computer mediates security and/or cryptographic operations on the network regarding a response.

FIG. 7 is an illustration of an embodiment in which the director computer mediates security and/or cryptographic operations on the network regarding an instruction 114.

FIG. 8 is an illustration of an embodiment in which a director computer does not reveal the presence of a worker computer connection.

FIG. 9 is an illustration of an embodiment in which the director computer may or may not determine in part the contents of an instruction received from an assignment computer connection.

FIG. 10 is an illustration of an embodiment wherein the director computer 100 divides some of said instructions into portions and performs assignment of the portions based on computational capacities.

FIG. 11 is an illustration of an embodiment which employs redundancy to verify the responses from worker computers.

FIG. 12 is an illustration of an embodiment in which the director computer divides the set 118 of elements to be tested into two or more subsets of elements.

FIG. 13 is an illustration of an embodiment in which the director computer combines two or more instructions received from assignment computer connections into an instruction.

FIG. 14 is an illustration of an embodiment which includes two worker computer connections each characterized by at least one type of computation.

FIG. 15 is an illustration of an embodiment which includes two worker computer connections 104 each characterized by at least one computational resource.

FIG. 16 is an illustration of FIGS. 16A and 16B in combination, and these collectively illustrate embodiments of an instruction.

FIG. 16A is a portion of an illustration of embodiments of an instruction.

FIG. 16B is a portion of an illustration of embodiments of an instruction.

FIG. 17 is an illustration of embodiments of one or more worker computers.

FIG. 18 is an illustration of embodiments of a worker computer connection.

FIG. 19 is an illustration of embodiments of one or more assignment computer connections.

### DETAILED DESCRIPTION

By way of an overview, the inventors herein observed that certain network architectures and features thereof have limitations that may not have previously observed. There can be a one-to-one relationship between assignment computers and worker computers in prior architectures, which results in assignment computers issuing instructions that do not allow the efficient usage of worker computer resources or the implementation of certain policies of how worker computer resources are to be distributed to users. This one-to-one relationship and its implications for network architecture accord an opportunity for improvement.

Consider, for example, a proxy server that essentially does not change an instruction that is forwarded to the groups of computers; it relays the instruction essentially unchanged and relies on the computer executing the program to interpret the instruction. Because the proxy server does not interpret the instructions, and it only forwards them, it does not make modifications to the instructions so that the worker computers can perform the instructions more efficiently, or enable more users to share the worker computer resources. The one-to-one relationship between the instructions issued to the proxy server and the instructions relayed to the worker computers is due to the instructions and responses being directly passed by the proxy server between the assignment computers issuing instructions and the worker computers performing the instructions, and so the assignment computer creates instructions suited for a particular worker computer. However, the assignment computer may not be able to create the instructions best suited to take advantage of the capabilities of the worker computer(s), or to create instructions that are consistent with a particular policy of sharing worker computer resources. The assignment computer may not be able to obtain information about the worker computers or the network architecture on which the worker computers reside to best create these instructions, and therefore the worker computers are underutilized or utilized with suboptimal performance. That is, typically with a proxy server, a worker computer may be selected to perform the instruction at the time the instruction is received, rather than predetermining the worker computer(s) that performs the instruction or reconfiguring the network architecture to better handle the instruction.

The forgoing issues become amplified to great significance in computing at scale, and often, teams of worker computers numbering in the hundreds to millions are tasked with finding solutions to particular mathematical or combinatorial problems. These problems include determining the correct conformation of proteins, analyzing signals acquired from radio telescopes, finding the optimal routing paths of thousands of delivery trucks, routing paths around printed circuit boards or integrated circuits, testing cryptographic keys to attempt to break ciphers or determine if a signature is forged, cryptocurrency mining, etc. A vast number of solutions must be attempted by these enormous teams of computers, and the inventors have observed that networking infrastructure would be useful for distributing the work to computers within the teams so that the solutions may be efficiently searched, and the proposed solutions verified. The inventors have also observed that a network can be designed specifically for assigning the requests to search for solutions to particular worker computers and then to relay the results of these searches to the computer requesting the search. Because of the enormous scale of these searches, the inventors have further observed that several strategies can be used to distribute the work. The embodiments herein illustrate implementation of various strategies in order to adapt configurations of worker computers and problem search sizes. For example, depending on the available worker computers and the searches to be performed, larger search spaces can be divided into smaller spaces, or alternatively, smaller searches aggregated into a single search.

In an instruction, a solution to a problem can be defined in a way that one or more proposed solutions comprise a set of elements, with each element being a potential solution to the problem. Each element can be subjected to a test, which is implemented by a computer specially programmed so that the result of the test registers whether or not the element satisfies a particular condition. Each element can be subjected to a test, which is implemented by a computer specially programmed so that the result of the test registers whether or not the element satisfies a particular condition. For example, in an orbital dynamics simulation, an element may be an initial configuration of planetary bodies and spacecraft bodies, and the test could determine the evolution of the bodies, and the desired condition could be that the spacecraft is located in a particular position at the end of the simulation. As another example, a protein folding simulation may assign a particular starting protein conformation as an element, the test could be a simulation of the motions of the amino acids, and the condition could be that the energy of the conformation has been reduced by a certain desired amount below the initial energy before simulation. Yet another example, involving cryptography, involves finding a nonce that, when cryptographically hashed with a given bit pattern, generates a number less than or equal to a certain integer. In this example, the elements are the nonces to be tested, the test is the cryptographic hashing operation, and the desired condition is that the result of the cryptographic hash operation is less than or equal to a certain integer. Even though all of these problems appear to be quite different types of computations, these all have in common that, when being solved at large scales, a network architecture that can efficiently distribute the task of finding solutions, if any, to many networked computers.

Accordingly, in connection with the embodiments used collectively to teach the broader principles herein, as a teaching example, consider a network architecture structure. The teaching structure can include a director computer, which can be implemented by one or more computer systems acting in concert, depending on the configuration of particular preference. The director computer receives instructions to test a set of elements to determine whether these elements are solutions to a problem defined by a condition. These instructions are received, typically individually, from assignment computers that each request the tests. The director computer assigns each instruction to a worker computer and then sends the instruction to the worker computer. The director computer may receive a response from the worker computer that identifies one of the elements of the set that the worker computer tested as satisfying the condition and therefore solves the problem. The director computer sends the identity of this solution to the assignment computer that requested the test. If the worker computer did not identify any of the elements as satisfying the condition, the director computer may indicate to the assignment computer that no elements were identified as satisfying the condition.

The foregoing has many implications for network architecture, and a variety of teaching embodiments illustrate the broader principles herein. For example, the director computer can divide a single set of elements to be tested into several smaller sets of elements, each of which may be tested independently by respective worker computers. Alternatively, the director computer can combine sets of elements into a single set of elements that can be tested by a worker computer. In another example, the director computer can direct instructions to particular worker computers that are able to perform particular types of tests, and/or the director computer can assign work to worker computers capable of performing particular tests that require particular computing resources. And after a network architecture is configured to handle an instruction, the network reconfigures to handle a subsequent instruction, e.g., using any combination of such as the foregoing.

As may be preferred in one application or another, the director computer may mediate authentication, encryption, or other computer security measures to ensure the integrity of the network and the solutions that are produced by the worker computers on the network. This can be especially useful where the computational effort, to which various participants and/or organizations are contributing by using the network, is audited.

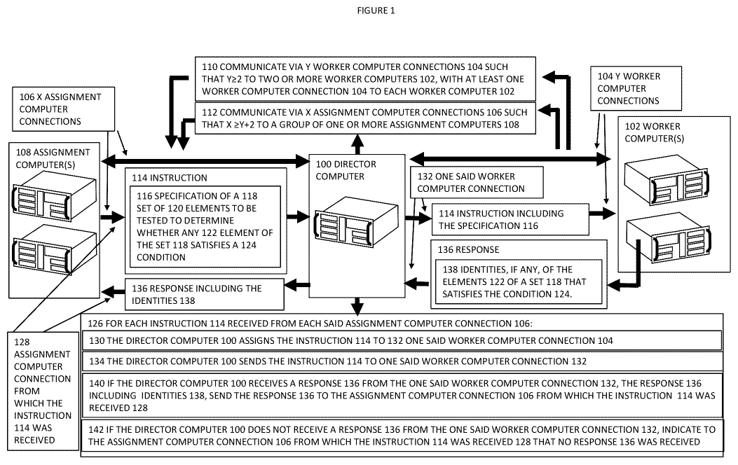

FIG. 1 illustrates an embodiment, and to understand the flow of the network that is formed in this particular teaching embodiment, a director computer 100 is configured to communicate with each of one or more worker computers 102 through Y≥2 worker computer connections 104, where Y is the countable number of worker computer connections 104. The director computer 100 is configured to communicate with X≥Y+2 assignment computers 108, where X is the number of assignment computer connections 108, via assignment computer connections 106. The director computer 100 receives instructions 114 from assignment computer connections 106 and sends the received instructions 114 to worker computer connections 104. In some, but not all, embodiments, the director computer 100 receives responses 136 from worker computer connections 104 and sends responses 136 to assignment computer connections 106.

An instruction 114 may request, for example, that a worker computer 102 test a set 118 of elements to determine whether any element 122 of the set 118 satisfies a condition 124. Instructions 114 may be received by the director computer 100 communicated over an assignment computer connection 106 from an assignment computer 108. A condition to be satisfied 124 can be determined by the problem to be solved. For example, for a protein folding simulation, a condition to be satisfied 124 may be a particular protein conformation with reduced energy. For factoring integers, a condition to be satisfied 124 could be that the identified integer factors multiply together to be the integer that is to be factored. For cryptocurrency mining, a condition to be satisfied 124 could be the identification of a nonce that, when hashed by a particular cryptographic hash algorithm, produces an integer less than a certain target number. The possible solutions to be tested are a set 118, and the individual potential solutions within this set 118 are the elements 122 of the set. An instruction 114 generally includes, indicates, specifies, or implicates a type of test to be performed, and the specification 116 of the set 118 of elements 120 to be tested, to determine whether any element 122 of the set 118 satisfies a condition 124. If, for example, an instruction 114 includes a larger set 118 of elements to be tested 120, generally more work is required of the worker computers 102 that perform the instruction 114 to test the set 118 of elements 120. The worker computers 102 with sufficient computational capacity can be used to perform the instruction 114, with the needed computational capacity generally increasing as the set 118 of elements to be tested 120 increases in size. Generally, as the instruction 114 determines the amount of the computational capacity of the worker computers 102 that is needed to perform the instruction 114, by changing the instruction 114, the amount of computational capacity needed for the worker computers 102 to perform the instruction 114 can be altered, e.g., to suit the computational capacity of the worker computers 102 to be committed to performing the instruction 114.

What constitutes relevant measures of computational capacity depends on the particular test being performed by a worker computer 102. For example, if a simulation is being performed, e.g., a simulation of protein folding or a planetary dynamics simulation, a relevant measure of computational capacity may be the number of cycles of simulation that to be performed within a given interval of time. Similarly, if performing cryptographic hash operations to find a nonce such that the cryptographic hash is an integer less than or equal to a target number, the number of cryptographic hash operations that may be performed within a given interval of time is a relevant measure of computational capacity. For types of computations involving floating point operations, a number of floating-point operations per interval of time may be a measure of computational capacity. For graphics processing units, the number of graphics processing units or a number of geometric operations per interval of time may be a measure of computational capacity. Particular application specific integrated circuits may be required for a particular test, and a relevant measure of computational capacity may be the number of application specific integrated circuits of a particular type or model present. Another measure of computational capacity may be a quantity of random-access memory or nonvolatile memory. An instruction 114 received by a director computer 100 may indicate more than type of computational resource, and the director computer 100 may be required to find a worker computer or several worker computers 102 that have the indicated computational resources to assign the instruction 114 to.

Worker computers 102 that perform the instruction 114 test elements of the set 116 to be tested 120. If a worker computer 102 determines that an element 122 satisfies the condition 124 given by the test, the worker computer 102 may return a response 136 to the director computer 100 via a worker computer connection 104 which includes the identity of one or more elements 122 of the set 118 that satisfies the condition 124. If the worker computer 102 tests the set 118 of elements to be tested 120 and did not identify an element 122 of the set 118 satisfies the condition 124, the worker computer 102 may return a response 136 to the director computer 100 via a worker computer connection 104 indicating that the worker computer 102 did not identify an element 122 of the set 118 that satisfies the condition 124.

Hypothetically, consider an assignment computer 108 that communicates directly to a worker computer 102 and does not have its communications mediated by a director computer 100 and receives the information about the computational capacity of the worker computer 102 directly from a worker computer 102, and in response to receiving this information, the assignment computer 108 issues an instruction 114 to the worker computer 102 that utilizes the computational capacity of the worker based on the information. Because the hypothetical worker computer 102 usually communicates its full computational capacity to the assignment computer 108, the instruction 114 issued by the assignment computer 108 generally make use of, e.g., fully utilizes the computational capacity of the worker computer 102. An instruction 114 issued by the hypothetical assignment computer 108 that utilizes the full capacity of a worker computer 102 may not be desirable in many situations.

However, as described herein, a director computer 100 can mediate the communications between the assignment computers 108 with assignment computer connections 106 and with the worker computers 102 with worker computer connections 104 so that the assignment computers 108 and the worker computers 102 do not directly communicate. Because the communications between a worker computer 102 and an assignment computer 108 can be mediated by a director computer 100, the director computer 100 may alter the information about the computational capacity of a worker computer 102 when this information is communicated to an assignment computer 108. The assignment computer 108 then issues instructions 114 based on the altered information about the computational capacity, and the director computer 100 can then influence the amount of computational capacity required by an instruction 114 by communicating a computational capacity of one or more worker computers 102 to an assignment computer 108 that achieves an instruction 114 that utilizes a desired computational capacity of a worker computer 102 which does not necessarily utilize the full computational capacity of the worker computer 102. In this way, a director computer 100 may receive instructions 114 from assignment computers 108 that utilize a target amount of computational capacity on one or more worker computers 102.

The director computer 100 communicates 110 via Y worker computer connections 104 such that Y≥2 to two or more worker computers 102, with at least one worker computer connection 104 to each worker computer 102. The director computer 100 communicates 112 via X assignment computer connections 106 such that X≥Y+2 to a group of one or more assignment computers 108. Using the pigeonhole principle, if there are Y number of worker computer connections 104, and the X number of assignment computer connections 106 is at least two greater than the Y number of worker computer connections 104, then there must be at least two worker computer connections 104 which may be associated with at least two assignment computer connections 106, or there must be a worker computer connection 104 which may be associated with three or more assignment computer connections 106. Therefore if X≥Y+2, there will be at least one worker computer connection 104 which may be assigned 130 work from at least two assignment computer connections 106, and because Y≥2 there are at least two worker computer connections 104. If two or more assignment computer connections 106 are available for a worker computer connection 104, the director computer 100 can communicate a different computational capacity for each of the assignment computer connections 106, with the total of the computational capacity communicated to the assignment computer connections 106 being less than or equal to the worker computer connection 104 computational capacity. The assignment computers 108 may then issue instructions 114 over each of the assignment computer connections 106 that utilize the computational capacity communicated by the director computer 100 over each respective assignment computer connection 106. In this way, a director computer 100 may receive an instruction 114 from each of the assignment computer connections 106 that the director computer 100 is communicating for a given worker computer 102, and each of these instructions 114 may utilize a target amount of computational capacity given by the computational capacity communicated by the director computer 100 over the respective assignment computer connection 106. If the instructions 114 for the assignment computer connections 106 each only utilized a fraction of the computational capacity of the worker computer 102, then if only one instruction 114 was issued, this instruction 114 would utilize only part of the computational capacity of the worker computer 102 and the remainder of the computational capacity would be unused. If there are two or more instructions 114 that each use a fraction of the computational capacity are issued, the total of the computational capacity of these two or more instructions 114 can utilize the full capacity of the worker computer 102. Therefore, the director computer 100 creates two or more assignment computer connections 106 for a worker computer 102 so that the worker computer 102 can obtain two or more instructions 114, with each of these instructions partially utilizing the worker computer 102, but together the instructions utilize the entire capacity of the worker computer 102. This step enables a director computer 100 to flexibly partition the capacity of a worker computer 102 to adapt to different amounts of computational capacity available from worker computers 102, and to conform to a policy, as may be preferred in one application or another, of how the computational capacity of worker computers 102 is to be used.

As examples, there may be Y=3 worker computer connections 104, Y=5 worker computer connections 104, or Y=10 worker computer connections 104. As X≥Y+2, where there are Y=3 worker computer connections 104, there must be X≥5 assignment computer connections 106, so for example there may be X=7 assignment computer connections 106. When there are Y=5 worker computer connections, there must be X≥7 assignment computer connections 106, so for example there may be X=13 assignment computer connections 106. As a further example, when there are Y=10 worker computer connections 104, there must be X≥12 assignment computer connections, so for example there may be X=12 assignment computer connections.

A director computer 100 may receive an instruction 114 that includes a specification 116 of a set 118 of elements to be tested 120 to determine whether any element 122 of the set 118 satisfies a condition 124. For each 126 instruction 114 received from each said assignment computer connection 106, the director computer then can perform the following operations: The director computer 100 assigns the instruction 114 to one said worker computer connection 130. The director computer 100 sends the instruction 114 to the one said worker computer connection 134. If the director computer 100 receives a response 136 from the one said worker computer connection 132, the response 136 including the identities 138, if any, of the elements 122 of a set 118 that satisfy the condition 114, send the response 136 to the assignment computer connection from which the instruction 114 was received 128 140. If the director computer 100 does not receive a response 136 from the one said worker computer connection 132, indicate to the assignment computer connection from which the instruction 114 was receives 128 that no response 136 was received 142.

The action of the director computer 100 receiving the instruction 114 from an assignment computer connection 106 may be performed in many ways. For example, the instruction 114 includes a specification 116 of a set 118 of elements 120 to be tested to determine whether any element 122 of the set 118 satisfies a condition 124. The director computer 100 may receive the instruction 114 from an assignment computer connection 106 without being mediated by a proxy server of the network. Alternatively, the director computer 100 may receive the instruction 114 from a proxy server that mediates the assignment computer connection 106. A computer acting as a proxy server may be an other director computer 100. There may be multiple director computers 100 mediating the communication of an instruction 114 and responses 136 between an assignment computer 108 and a worker computer 102. Various methods and policies for managing computational capacity may be implemented by either one director computer 100 that mediates between an assignment computer 108 and a worker computer 102, or many director computers 100 that each implements a method or policy for managing computational capacity. The methods a director computer 100 may use, to receive instructions 114 from assignment computer connections 116 and arrange one or more director computers 100 to mediate between assignment computers 108 and worker computers 102, depend on the particular embodiment that may be preferred in one case or another.

Also, the action of the director computer 100 assigning the instruction 114 to one said worker computer connection 132 130 can be performed in many ways. For example, one method of performing the action is for the director computer 100 to associate a worker computer connection 104 with one or more assignment computer connections 106, and then assign the instruction received over an assignment computer connection 106 to the associated worker computer connection 104. The director computer 100 may maintain records of the instructions 114 being performed on worker computers 102 as well as records of the computational capacity utilized by the performance of the instructions 114 on the worker computers 102. When receiving an instruction 114, the director computer 100 may identify one or more worker computers 102 that has computational capacity available to perform the instruction 114 and assign the instruction 114 to those one or more worker computers 102. The director computer 100 may implement a policy of how the computational capacity of the worker computers 102 is to be used. For example, a certain amount of computational capacity may be dedicated or selectively dedicated to be utilized by a particular computer user or group of computer users so that a requisite computational capacity of the worker computers 102 is operated in accordance with the directives of the computer user or group of computers users, e.g., with the director computer 100 configuring one or more worker computers 102 to operate in accordance to these directives and to perform instructions 114 that utilize the requisite computational capacity in accordance to these directives. The director computer 100 may be issued an authentication token, for example a non-fungible token, which is used to authorize a directive as to how requisite computational capacity of the worker computers 102 is to be operated, and the director computer 100 may configure the worker computers 102 to operate in accordance with these directives and perform instructions 114 that utilize the requisite computational capacity in accordance with these directives. The methods a director computer 100 may use, to assign instructions 114 to worker computer connections 130, depend on the particular embodiment that may be preferred in one case or another.

A director computer 100 that assigns an instruction 114 received from an assignment computer connection 106 to one said worker computer connection 132 130 may select instructions 114 that it receives from any of the assignment computer connections 106 to assign 130 to one said worker computer 114. The director computer 100 may select or reselect one or more of the assignment computer connections 106 so that the instructions 114 that are assigned to the worker computer connection 104 are received from the selected or reselected one or more assignment computer connections 106. A director computer 100 may select or reselect assignment computer connections 106 that can send instructions 114 that partially or fully utilize the resources of a worker computer connection 104 as given by a particular policy of utilization of the worker computer connection 104. In particular, as a director computer 100 communicates with two or more assignment computer connection 106 for a worker computer connection 104, the director computer 100 may select or reselect two or more assignment computer connections 106 that send instructions 114, each of which partially utilize the computational capacity of a worker computer connection 104, but the total computational capacity utilized by the instructions 114 use or fully utilize the computational capacity of the worker computer connection 104. In addition, a director computer 100 may initiate assignment computer connections 106 so that it can obtain instructions 114 that partially or fully utilize the capacity of the worker computer connection 104. Because a director computer 100 may initiate assignment computer connections 106 and change the selection of assignment computer connections 106 that the director computer 100 communicates via for a worker computer connection 104, the director computer 100 can dynamically configure, reconfigure, or both to enable the network architecture to receive instructions 114 from assignment computer connections 106 that make use of, e.g., fully utilize, the computation capacity of a worker computer connection 104. The dynamic reconfiguration of the network architecture through initiating assignment computer connections 106 and/or selecting assignment computer connections 106 enables the director computer 100 to obtain instructions 114 from assignment computer connections 106 that utilize a needed amount of computational capacity of the worker computer connection 104 so that the utilization of computational capacity of the worker computer connection 104 conforms to a policy of worker computer 102 computational capacity utilization.

The action of a director computer 100 sending the instruction 114 to the one said worker computer connection 134 may be performed in many ways. For example, the director computer 100 may identify a network connection which implements a worker computer connection 104 that has been assigned the instruction 114 by the director computer 100, and then send the instruction 114 to the worker computer connection 114 so identified. The director computer 100 may identify an other computer, such as a proxy server that mediates the worker computer connection 104, and send the instruction 114 to the other computer that then relays the instruction 114 to the worker computer connection 104. An other computer acting as a proxy server may be an other director computer 100. The methods a director computer 100 may use, to send the instruction 114 to the one said worker computer 134, depend on the particular embodiment that may be preferred in one case or another.

The action of a director computer 100 receiving a response 136 from the one said worker computer connection 132, the response 136 including the identities 138, if any, of the elements 122 of a set 118 that satisfy the condition 114, and sending the response 136 to the assignment computer connection 106 from which the instruction 114 was received 128, 140 may be performed in many ways. For example, the director computer 100 may receive the response 136 from the worker computer connection 132 or an other computer such as a proxy server which mediates the one said worker computer connection 132. An other computer acting as a proxy server may be an other director computer 100. The director computer 100 may send the response 136 to the assignment computer connection 106 from which the instruction 114 was received, and the assignment computer connection 106 may be a connection not mediated by a proxy server, or may be mediated by a proxy server, and an other director computer 100 may serve as a proxy server. The response 136 may indicate to the assignment computer connection 106 from which the instruction 114 was received the identity of any elements 122 that satisfy the condition 124 that are received in the response 136 from the one said worker computer connection 132. Or if the director computer 100 did not receive the identity of any elements 122 that satisfies the condition 124 in the response 136 from the one said worker computer connection 132, the director computer 100 may indicate in the response 136 to the assignment computer 106 from which the instruction 114 was received that no elements 122 that satisfy the condition 124 were identified. If the director computer 100 does not receive a response 136 from the one said worker computer connection 132, the director computer 100 may indicate to the assignment computer connection 106 from which the instruction 114 was received 128 that no response 136 was received 142. The director computer 100 may wait a predetermined period of time to receive a response 136 from the one said worker computer connection 132 after the instruction 114 was sent by the director computer 100 to one said worker computer connection 132. If no response 136 is received by the director computer 100 within that time, the director computer 100 may indicate to the assignment computer connection 106 from which the instruction 114 was received 128 that no response 136 was received. The one said worker computer connection 132 may indicate a fault, for example, a failure of the worker computer 102 performing the instruction 114, or a failure of the network on which the one said worker computer connection 132 operates, and then the director computer 100 may indicate to the assignment computer connection 106 from which the instruction 114 was received 128 that no response 136 was received 142. The director computer 100 may decide to send a new instruction 114 to the one said worker computer connection 132 so that the worker computer receiving the instruction 114 terminates performing an instruction 114 already sent by a director computer 100 to the worker computer and performs the new instruction 114. The director computer 100 may then indicate to the assignment computer connection 106 from which the instruction 114 which had its performance terminated was received that no response was 136 received 142. The methods a director computer 100 may use, to send the response 136 to the assignment computer connection 106 from which the instruction was received 114 or indicate to the assignment computer connection 106 from which the instruction was received 114 that no response 136 was received, depend on the particular embodiment that may be preferred in one case or another.

The director computer 100 may communicate with assignment computer connections 106 that are local area networks, wide area networks, wireless networks, packet switching networks, store-and-forward networks, etc. Similarly, the director computer 100 may communicate with worker computer connections 104 that are local area networks, wide area networks, wireless networks, packet switching networks, store-and-forward networks, etc. The assignment computers may each be commodity computing hardware equipment, for example based on Intel or ARM processors, with volatile RAM memory, rotating media storage or solid-state nonvolatile storage, network interfaces for connecting to local or wide area networks, etc. An operating system such as Linux, Windows, or a BSD variant may be executing on the commodity computing hardware. The assignment computers may be organized into a high-performance computing cluster to act in concert. The worker computers 102 may similarly be commodity computing hardware similarly equipped or may also have specialized computing resources such as application specific integrated circuits, field programmable gate arrays, or graphics processing units. The director computer 100 may be a single computer or many computers acting in concert. The director computers 100 may likewise be commodity computing hardware equipment. The director computer may have multiple network interfaces so that the assignment computer connections 106 and the worker computer connections 104 are on separate networks and instructions 114 and responses 136 are passed between the networks by the director computer 100.

An embodiment for dynamic physical simulations, for example, simulations of protein folding or N-body dynamics simulations is described below. An assignment computer 108 creates instructions 114 that contain a specification of a physical situation to be modeled, for example, a particular order of amino acids for a protein folding simulation, or a particular initial configuration of bodies for a N-body dynamics simulation. These assignment computers 108 may be commodity hardware computing equipment as described organized into a computing cluster. The instruction 114 also contains a specification 116 of a set 118 of elements to be tested 120 to determine whether any element 122 of the set 118 satisfies a condition 124. The set 118 may be variations on the physical situation to be modeled, for example, perturbations of the initial conditions of the simulation, the addition or removal of particular amino acids or bodies, and the elements 120 of the set 118 are the individual situations to be tested 120. The specification 116 may indicate a desired outcome of the simulation, for example, a reduction in an energy functional by a certain amount that is determined by the physical parameters, or a configuration with desired properties to be achieved at the end of the simulation. The assignment computers 108 then send the instructions 114 to a director computer 100. The director computer 100 can, but need not always, be commodity computing hardware organized into a network or existing on a cloud. The director computer 100 receives an instruction 114 from an assignment computer connection 106 and examines the size of the set 118 to determine the computational capacity required to perform the simulations specified in the set 118. The director computer 100 then selects one said worker computer connection 132 that communicates the instruction 114 to a worker computer 102 that has the available computational capacity to perform the instruction 114. The director computer 100 may receive the response 136 from the one said worker computer connection 132. The response 136 contains the elements 122 of the set 118 that satisfies the condition 124, if any were found by the worker computer 102. Each of these elements 122 corresponds to an initial condition, for example, which produced a configuration at the end of the simulation with the desired properties. The director computer 100 sends this response 136 to the assignment computer connection 106 from which the instruction 114 was received 128 140. The worker computer 102 generally is no longer working on the instruction 114, which is registered by the director computer 100, and so the computational resources used to perform the instruction 114 are no longer being utilized, and therefore the director computer 100 may direct another instruction 114 to the worker computer connection 104 to utilize the available computational resources. If no response 136 is received from the one said worker computer connection 132, the director computer 100 indicates to the assignment computer connection 106 from which the instruction 114 was received 142. There will be two or more assignment computer connections 106 for at least one worker computer connection 104. The director computer 100 may cause an assignment computer 108 to send instructions 114 that utilize only part of the computational capacity of a worker computer 102. For example, the size of the set 118 of elements 120 to be tested included in an instruction 114 received from an assignment computer connection 106 may only utilize a fraction of the computational capacity of the worker computers simulation capability, leaving the remainder of the simulation capability available for other instructions 114. By having two or more assignment computer connections 106, the instructions 114 to only use part of the simulation capability may be received and therefore provide the director computer 100 flexibility as to assigning worker computers to the instructions 114, so that the director computer 100 need not assign instructions 114 to a worker computer 102 that utilizes the full capacity the worker computer 102, leaving none remaining for other instructions 114. A policy of worker computer 102 utilization may require that a fraction of the simulation capacity remains available for further instructions 114, which would not be possible if there was only one assignment computer connection 106 for each worker computer connection 104 and the instructions 114 received used the full simulation capacity of worker computers 102.

Another embodiment for cryptocurrency mining, as noted above, can have an assignment computer 108 or a group of assignment computers 108 that may be one or more cryptocurrency mining pool computers. For a typical usage of a cryptocurrency mining pool, worker computers 102, which are typically cryptocurrency miner computers, directly communicates with the cryptocurrency mining pool without the instructions 114 or responses 136 passing through a mediating computer such as a director computer 100 or proxy server. The connection between a cryptocurrency mining pool and cryptocurrency miner may be Stratum protocol messages. Examples of cryptocurrency miner worker computers are by Bitmain (Antminer S9, S17, S19, etc.), AvalonMiner (A1166 Pro, 1246), WhatsMiner (M30S+), etc. In this case, the cryptocurrency mining pool sends instructions 114 to the cryptocurrency miner which instructs the miner to test cryptographic hashes in order to find a nonce such that the hashed integer value satisfies a particular condition 124, for example, being less than a particular target value. The instruction 114 also includes a set 118 of numbers to test to find the value that satisfies the condition 124. The cryptocurrency miner tests the numbers of the set 118 by hashing each number, usually with other information such as the hash of a previous block, a Merkle root (itself computed dependent on Merkle branches and/or extranonces), a timestamp, a network difficulty, a block version number, and other relevant information needed to create the block on a cryptocurrency blockchain. If the cryptocurrency miner finds such a hashed value that satisfies the condition 124, the miner sends a response 136 indicating the identity of a nonce that was hashed to satisfy the condition 124. The nonce may be hashed with the other information as proof that the hashed value satisfies the condition 124 to verify the nonce and prove that the miner performed the work of the instruction 114.

An embodiment for cryptocurrency mining may have a director computer 100 mediate between a cryptocurrency mining pool assignment computer 108 and a cryptocurrency miner worker computer 102. The director computer 100 receives instructions 114 to mine cryptocurrency from assignment computer connections 106. These instructions 114 receive a specification 116 of a set 118 of elements 120 to be tested to determined whether any element 122 of the 118 satisfies a condition 124. The specification of a set 118 of elements 120 to be tested is typically given by a set of nonces and extranonces to test, where each element 120 of the set 118 is a particular combination of nonce and extranonce. The set 118 may be specified as a part of an extranonce that is fixed and used by the miner unchanged, and a second part as a size that may be added by the miner to the fixed part so that a hashed value satisfying the condition 124 may be found. The condition 124 may be partially specified by a difficulty, which determines the acceptable hash values that a miner may obtain that satisfies the condition 124, with a higher difficulty generally corresponding to fewer acceptable hash values. The director computer 100 assigns the instruction 114 to one said worker computer connection 132. The director computer 100 may select a worker computer connection 104 based on the computational capacity of a worker computer 102, for example, measured in a number of cryptographic operations such as cryptographic hashes in a given time interval. If the instruction 114 specifies a set 118 with a larger number of elements 120 to test, for example, if the extranonce space that is to be searched has more bits of extranonce that may be added by the miner, the director computer 100 may select a cryptographic miner with a greater computational capacity, for example, a higher number of cryptographic hashes per time interval, to perform the instruction 114 as the cryptographic miner is able to search the larger set 118 more quickly. Similarly, if the instruction 114 specifies a higher difficulty, generally more elements 120 (each for example being a combination of a nonces and an extranonce) need to be tested by the cryptocurrency miner to find an element 122 of the set 118 that satisfies the condition 124, that is, has a cryptographic hash value that is within the bounds that are determined by the difficulty. Therefore, the director computer 100 may assign an instruction 114 with a higher difficulty to level to a cryptographic miner worker computer 102 with a greater computational capacity, for example, a higher number of cryptographic hashes per time interval, so that the cryptographic miner may find an element 122 that cryptographically hashes to an acceptable value within the bounds determined by the difficulty.

A cryptocurrency miner worker computer 102 performs an instruction 114 to test the set 118 of elements 120 to determine whether any element 122 satisfies the condition 124 by testing each element (each, for example, being a combination of a nonces and an extranonce) to determine if the cryptographic hash of the element including the other information is within the bounds that are determined by the difficulty. If the cryptocurrency miner communicated to by the director computer 100 via a particular worker computer connection 104 identifies such an element 122, particular worker computer connection 104 may send a response 136 to the director computer 100 with the identity of the element 122. This response 136 may include the worker computer 102 name, an identifier of a job given to the cryptocurrency miner by the cryptocurrency mining pool, a time that may be encoded into the block hash, and a nonce and extranonce that identify the element 122. The director computer 100 may record the instructions 114 that have been sent to worker computer connections 104 and record the identity of cryptocurrency miners communicated to on the worker computer connections 104, and the assignment computer connections 106 and identity of cryptocurrency mining pools the instructions 114 were received from by the director computer 100. The director computer 100 then may send the response 136 to the assignment computer connection 136 from which the instruction 114 was received. This may include relaying the response 136 including the same information in the response including the worker computer 102 name, identifier of the job, a time encoded into the block hash, a nonce and extranonce that identify the element 122, etc.

The director computer 100 may configure or reconfigure the connections to a cryptocurrency mining pool so that the pool sends instructions 114 that utilize only part of the computational capacity of a worker computer 102, for example, by sending instructions 114 with a reduced difficulty so that a cryptocurrency miner performing the instruction 114 requires less time to find an element 122 that satisfies the condition 124. The director computer 100 may request to the cryptocurrency mining pool a difficulty for an instruction 114 so that the performance of the instruction 114 utilizes only a fraction of the computational capacity (for example, number of cryptographic hashes per interval of time) of a cryptocurrency miner, and the remainder of the computational capacity of the cryptocurrency miner is available for performing other instructions 114. By having two or more assignment computer connections 106 from the director computer 100 to a group of one or more cryptocurrency mining pools, the director computer 100 may request to the cryptocurrency mining pools that instructions 114 sent by the cryptocurrency mining pools each utilizes only a fraction of the computational capacity of a cryptocurrency miner. The assignment computers 106 may then send instructions 114 with a difficulty that is requested by the director computer 100, with the instructions 114 of said difficulty each utilizing only a fraction of the computational capacity of a cryptocurrency miner. This way, the computational capacity of a cryptocurrency miner may be partitioned in a way consistent with a particular policy of cryptocurrency miner utilization, as the instructions enable a sufficiently fine-grained utilization of the computational capacity of the cryptocurrency miner. An director computer 100 may be able to obtain instructions 114 for only one particular worker computer connection 104 over an assignment computer connection 106, and the director computer 100 may not be able to receive another instruction 114 from the assignment computer connection 106 until the response 136 to the instruction 114 has been sent by the director computer 100 to the assignment computer connection 106. An example of an assignment computer connection 106 with such a limitation is a connection to a cryptocurrency miner pool with the Stratum protocol. If the director computer 100 has only one assignment computer connection 106 receiving instructions 114 for a particular worker computer connection 104, then it can receive only one instruction 114 for the worker computer connection 104 until the response 136 to the instruction 114 has been sent by the director computer 100 to the assignment computer connection 106. If the instruction 114 received by the director computer 100 from the one assignment computer connection 106 for a worker computer connection 104 utilizes only a fraction of the computational capacity of the worker computer 102 performing the instruction 114 received from the worker computer connection 104, another instruction 114 is not available to utilize the remainder of the computational capacity of the worker computer 102 because there are no additional assignment computer connections 106 from which the director computer 100 may receive additional instructions 114 for the worker computer connection 104. The director computer 100 may need at least two assignment computer connections 106, each of which can receive an instruction 114 for the one worker computer connection 104, so that the director computer 100 may obtain two or more instructions 114, one instruction 114 from each of the assignment computer connections 106, with each instruction 114 perhaps only partially utilizing the computational capacity of the worker computer 102 receiving instructions 114 from the worker computer connection 104, so that the director computer 100 need not send a response 136 to an instruction 114 before receiving another instruction 114, so that the instructions 114 that may be received by the director computer 100 before responses 136 are returned for the instruction 114 may make use of, e.g., fully utilize, the computational capacity of the worker computer 104 receiving the instructions 114 from the worker computer connection 104. The director computer 100 may direct two or more assignment computer connections 106 to send instructions 114 for a worker computer connection 102 so that each instruction 114 utilizes a specified fraction of the computational capacity of the worker computer 102 connected to the worker computer connection 104, with the computational capacity utilized by each instruction 114 conforming to a particular policy of computational capacity utilization of the worker computers 104.

Instead, as is herein disclosed, the director computer 100 therefore reconfigures the connections so that there are least two assignment computer connections 106 for a worker computer connection 104 so that it may obtain instructions that each partially utilize a worker computer 102.

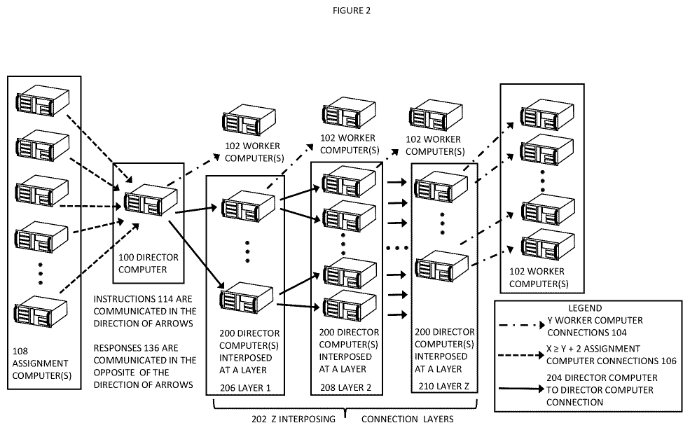

FIG. 2 is an illustration of an embodiment in which additional director computers are organized into Z interposing layers to distribute instructions from assignment computers 108 to worker computers 102. Each arrow on the Figure represents a connection, with the type of connection indicated by the shaft of the arrow. A shaft of alternating dots and lines indicates a worker computer connection, a shaft of a series of dashed lines indicates an assignment computer connection, and a shaft of a solid line indicates a connection between a director computer and another director computer. The arrow head each the arrow representing a connection indicates the direction in which instructions 114 are communicated on the connection, while the corresponding responses 136 to the instructions 114 are communicated in the opposite direction pointed to by an arrow head. The assignment computers 108 communicate instructions 114 to the director computer 100 via assignment computer connections 106 as indicated. As in FIG. 1, the director computer 100 may be connected to worker computer connections 104, and assign the instructions 114 to worker computer connections 104. However, the director computer 100 may be connected to another 200 director computer interposed at a layer. The director computer that is interposed at a layer 200 may be interposed between the director computer 100 and a worker computer 102. A director computer interposed at a layer 200 mediates the communication of instructions 114 and responses 136 between the director computer 100 and a worker computer 102. A director computer 100 may communicate an instruction 114 to a director computer 200 interposed at a first layer 206 through a director computer to director computer connection 204. The director computer 200 interposed at a first layer 206 may communicate the instruction 114 received from the director computer to director computer connection 204 to a worker computer connection 104, and receive a response 136 from the worker computer connection 104. The director computer 200 interposed at a first layer 206 may then communicate the response 136 to the director computer to director computer connection 204. The director computer 100 may receive the response 136 from the director computer to director computer connection 200 and communicate the response 136 to the assignment computer connection 106 from which the instruction 114 was received 128. The mediation of the communication of instructions 114 and responses 136 between the director computer and a worker computer 102 by a director computer interposed at a layer 200 enables a director computer 100 maintain indirect communication with many worker computers 102, and furthermore, a director computer interposed at a layer 200 may alter instructions 114 to and aggregate responses 136 from worker computer connections 104 as to redistribute work between the worker computers 102 or provide for fail-over redundancy or other redundancy to increase the reliability of the network.

A further embodiment may use Z layers of director computer(s) interposed at a layer 200 to mediate the communication of instructions 114 and responses 136 between a director computer and another director computer or a worker computer connection 104. There may be Z interposing connection layers 202 between a director computer 100 and a worker computer 102. A director computer 200 interposed at the first layer (Z=1) 206 interposes communications between the director computer 100 which communicates to the assignment computer connections 106 and director computer(s) 200 interposed at the second layer (if there are such director computers) and/or worker computer connections 104. For layers Z≥2, a director computer 200 interposed at layer Z 210 mediates communication between director computers 200 interposed at layer Z−1 and director computers 200 interposed at layer Z+1 (if there are such director computers) and/or worker computer connections 104. Instructions 114 are communicated between director computers 200 interposed from layers Z−1 to Z, and the corresponding responses are communicated between director computers 200 interposed from layers Z to Z−1. For layer Z=1, the instructions 114 are received by a director 200 computer interposed at layer 1 206 from the director computer 100 and the corresponding responses 136 are sent by a director computer 200 interposed at layer 1 206 to the director computer 100. By reconfiguring the network with Z interposing connection layers 202 between a director computer 100 and a worker computer 102, the many worker computers 102 can be in communication with the director computer 100 through the director computers interposed at layers 200.

For example, there may be Z=0 interposing connection layers 202 between the director computer 100 and one said worker computer 102. In this case, the one said worker computer 102 receives communications from a worker computer connection 104 without any layers interposed between the one said worker computer 102 and the director computer 100. As further examples, there may be Z interposing connection layers 202 between the director computer 100 and one said worker computer 102, with Z=3, Z=5, or Z=10.

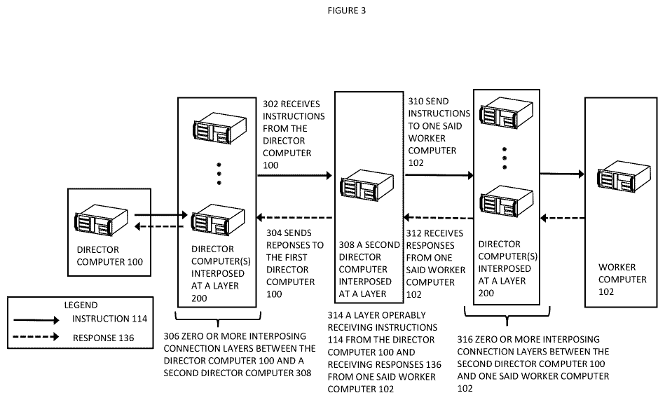

FIG. 3 is an illustration of a second director computer interposed at a layer. Each arrow in the Figure represents a communication between computers. An arrow with a solid shaft indicates an instruction 114 that is communicated, and an arrow with a dotted line shaft indicates a response 136 that is communicated. A second director computer interposed at a layer 308 may be interposed at a layer Z=1, in which case it communicates between a director computer 100 and another director computer interposed at layer Z=2 200 and/or a worker computer connection 104, or at a layer Z≥2, in which case it communicates between a director computer interposed at layer Z−1 200 and a director computer interposed at layer Z+1 200 (if such a director computer exists) and/or a worker computer connection 104. There may be zero or more interposing layers 306 between the director computer 100 and a second director computer 308, with the number of interposing layers being zero if the second director computer 308 is interposed on the first layer. Similarly, there may be zero or more interposing layers 316 between the second director computer 308 and one said worker computer 102, with the number of interposing layers being zero if the second director computer 308 communicates through a worker computer connection 104 to the worker computer 102. A layer may operably receive instructions 114 from the director computer 100 and receive responses 136 from the worker computer 102, for example, if a second director computer interposed at the layer 308 receives instructions from the director computer 100 and receives responses 136 from the worker computer 102 314. A second director computer interposed at a layer 308 between a worker computer 102 and a first director computer may receive instructions 114 from a first director computer 302, send instructions 114 to one said worker computer 102 310, receive responses 136 from the one said worker computer 102 312, and send responses to the first director computer 304. The first director computer may be a director computer 100 if the second director computer interposed at a layer 308 is interposed at the first layer, or the first director computer may be another director computer interposed at a layer Z−1 200 if the second director computer is interposed at a layer Z 308. The second director computer interposed at a layer 308 may communicate to a worker computer 102 either by a worker computer connection 104 or via other director computer(s) interposed at layers 200 between the second director computer interposed at a layer 308 at the worker computer 102.

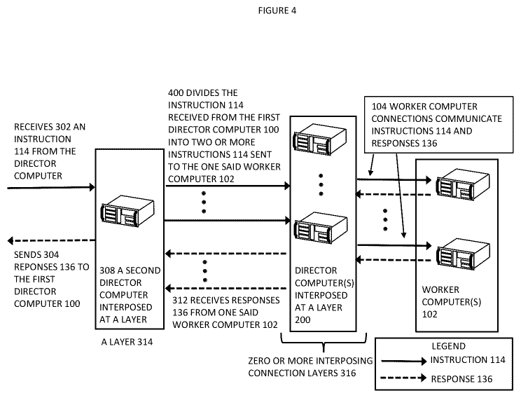

FIG. 4 is an illustration of a second director computer interposed at a layer that divides an instruction. Each arrow in the Figure represents a communication between computers. An arrow with a solid shaft indicates an instruction 114 that is communicated, and an arrow with a dotted line shaft indicates a response 136 that is communicated. A second director computer 308 interposed at a layer 314 receives 302 an instruction 114 from a director computer. The second director computer 308 divides the instruction 114 received from the first director computer into two or more instructions 114 400. An instruction 114 includes a specification 116 of a set 118 of elements 120 to be tested to determine whether any element 122 of the set 118 satisfies a condition 124. To divide the instruction 114, the second director computer 308 may create two or more subsets of the set 118, the members of each subset being elements of the set 118. The created subsets may be mutually disjoint, that is, no two of the subsets may have any common elements, so that two or more instructions 114 do not test the same one or more elements 120. The second director computer 308 creates an instruction 114 for each subset, each instruction including a specification 116 for which the set 118 is one of the created subsets. The second director computer 308 may then send the created instructions 114 to director computer(s) interposed at a layer 200 and/or the one said worker computer 102 400. The one said worker computer 102 may receive the instruction 114 through worker computer connections 104 and/or director computers interposed at a layer 200. The instructions 114 are performed by the one said worker computer 102 that receives the instructions 114 and the responses 136 to the instructions 114 are received by the second director computer 308 312, each response 136 include identities 138, if any, of the elements 122 of a set 118 that satisfies the condition 124. If the second director computer 308 receives in any responses 136 the identities 138 of any elements 122 of a set 118 that satisfies the condition 124, it may aggregate the identities 138 of the elements 122 into a response 136 that includes the identities 138. The second director computer 308 may then send the response 136 to the first director computer 100 304. If the second director computer 308 does not receive the identities 138 of any elements 122 of a set 118 that satisfies the condition 124, it may indicate to the first director computer 100 that no elements 122 of the set 118 that satisfied the condition 124 were identified.

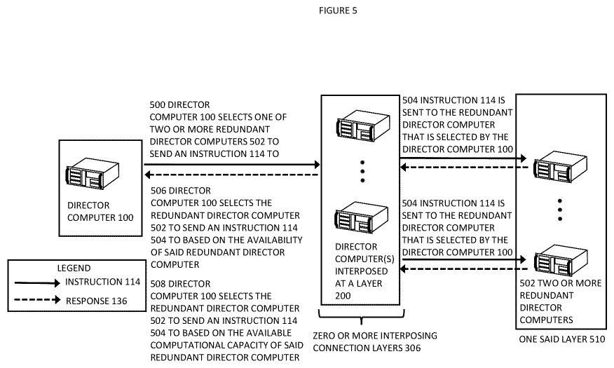

FIG. 5 is an illustration of an embodiment in which a first director computer selects one of two or more redundant director computers interposed at one said layer to send an instruction to. Each arrow in the Figure represents a communication between computers. An arrow with a solid shaft indicates an instruction 114 that is communicated, and an arrow with a dotted line shaft indicates a response 136 that is communicated. A director computer 100 selects one of two or more redundant director computers 502 to send an instruction 114 to 500. Redundant director computers 502 may be director computers interposed at one said layer 510, each redundant director computer perhaps interposed at different layers, wherein any of the redundant director computers 502 may perform a particular instruction 114 so that a director computer 100 may select any one of the redundant director computers 502 to perform the instruction 114. The instruction 114 is sent 504 to the redundant director computer 502 that is selected by the director computer 100, the communication possibly being mediated by other director computers interposed at layers 200. The instruction 114 is performed by a redundant director computer 502 by communicating the instruction 114 to a worker computer connection 104 with a corresponding worker computer 102 that performs the instruction 114, the communication to the worker computer connection 104 possibly being mediated by other director computers interposed at layers 200. The response 136 to the instruction 114 is received by the redundant director computer 502 which further communicates the response 136 to the director computer 100, the communication possibly being mediated by other director computers interposed at layers 200. The director computer 100 may select the redundant director computer 502 to send an instruction to based on the availability of said redundant director computer 502 506. A redundant director computer 502 may be considered available, for example, if it is hardware and software is operating within predetermined nominal operating parameters, if the redundant director computers 502 is able to send and receive and respond to communications to other director computers and worker computer connections, if the redundant director computer 502 is not inaccessible due to maintenance being performed, or a combination of these. If a redundant director computer 502 is not available, the director computer 100 may select another director computer 502 that is available to send an instruction 114 to. The director computer 100 may select the redundant director computer 502 to send an instruction to based on the available computational capacity of said redundant director computer 502 508. The available computational capacity of a redundant director computer 502 is determined by the available computational capacity of the worker computers 102 that the redundant director computer 502 may send instructions 114 to, with the communication with a worker computer 102 possibly being mediated by other director computers interposed at layers 200. If there are no worker computers 102 with the available computational capacity required to perform an instruction 114 that a redundant director computer 502 may send the instruction 114 to, the redundant director computer 502 does not have the available computational capacity to perform the instruction 114. The director computer 100 may query the redundant director computers 502 or worker computers 102, or maintain records of the instructions 114 being performed on the worker computers 102 to determine if a redundant director computer 502 has the available computational capacity to perform an instruction 114. The director computer 100 may then select a redundant director computer 502 with the available computational capacity to perform the instruction 114, and then send the instruction to the redundant director computer 502 with the available computational capacity.

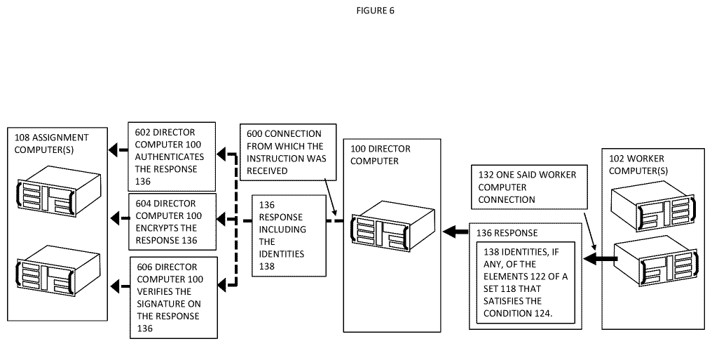

FIG. 6 is an illustration of an embodiment in which the director computer 100 mediates security and/or cryptographic operations on the network regarding a response 136 from a worker computer connection 104. A director computer 100 may authenticate 602 the response sent to the assignment computer connection from which the instruction 114 was received 600 that includes the identification of an element 122 of the set 118 that satisfies the condition 124. Such an authentication may be provided by a director computer 100 so that the director computer 100 verifies that the identity of the worker computer 102 sending the response 136 is actually the worker computer 102 and not another computer providing sending a deceptive response 136 that indicates that it is the worker computer 102. The director computer 100 may authenticate the response 136 using a combination of a worker computer identity and password, a challenge-response using either a shared secret associated with the worker computer identity or a signature of a public key associated with the worker computer identity, or a combination of these. A director computer 100 may encrypt 604 the response 136 sent to the assignment computer connection from which the instruction 114 was received 600 that includes the identification of an element 122 of the set 128 that satisfies the condition 124. The director computer 100 may encrypt 604 the response 136 in order to prevent the traffic from being eavesdropped by a malicious party attempting to interfere with traffic. The director computer 100 may encrypt 604 the response 136 using a method such as Transport Layer Security, Secure Sockets Layer, a symmetric cipher such as AES, asymmetric ciphers such as RSA or Diffie-Hellman, elliptic curve cryptography methods, or a combination of these. A director computer 100 may verify a signature 606 on a response 136 sent to the assignment computer connection 106 from which the instruction was received 600 that includes the identification of an element 122 of the set 118 that satisfies the condition 124. A director computer 100 may verify a signature 606 on a response 136 in order to ensure that the response 136 in fact was sent by a particular worker computer 102, with a particular signature key associated with the identity of the worker computer 102. A director computer 100 may verify a signature 206 on a response 136 by using the RSA signature method, DSA signature method, ECDSA signature method, etc.

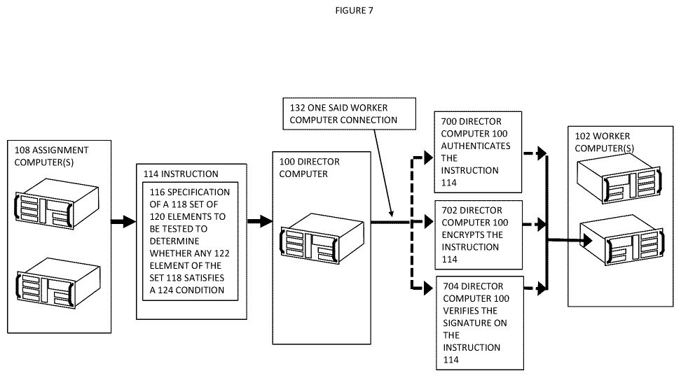

FIG. 7 is an illustration of an embodiment in which the director computer 100 mediates security and/or cryptographic operations on the network regarding an instruction 114 sent to a worker computer connection 104. A director computer 100 may authenticate 700 the instruction 114 sent to the one said worker computer connection 132. The director computer 100 may authenticate the instruction 114 so that the director computer 100 may verify that the instruction 114 originated from an assignment computer connection 106 with a particular identity, and not perhaps issued by a malicious party. The director computer 100 may authenticate the instruction 114 using a combination of an assignment computer identity and password, a challenge-response using either a shared secret associated with the assignment computer identity or a signature of a public key associated with the assignment computer identity, or a combination of these. A director computer 100 may encrypt 702 the instruction 114 sent to the one said worker computer connection 132. The director computer 100 may encrypt 702 an instruction 114 so that the instruction 114 is not eavesdropped by a malicious attacker. The director computer 100 may encrypt 702 the instruction 114 using a method such as Transport Layer Security, Secure Sockets Layer, a symmetric cipher such as AES, asymmetric ciphers such as RSA or Diffie-Hellman, elliptic curve cryptography methods, or a combination of these. A director computer 100 may verify a signature 704 on the instruction 114 send to the one said worker computer connection 132. The director computer 100 may verify a signature 704 on the instruction 114 to ensure that instruction 114 originated from a trusted assignment computer connection 106. A director computer 100 may verify a signature 704 on an instruction 114 by using the RSA signature method, DSA signature method, ECDSA signature method, etc.

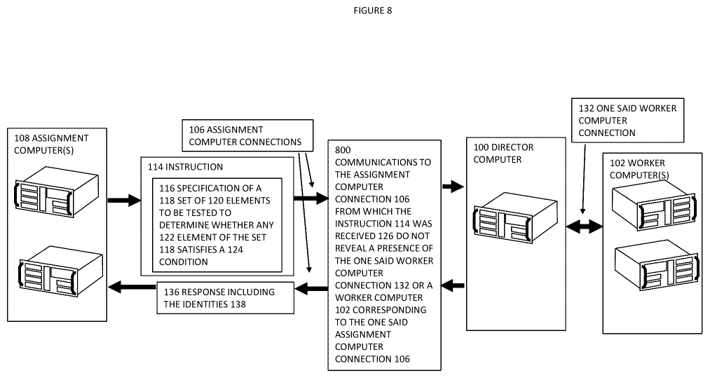

FIG. 8 is an illustration of an embodiment in which a director computer 100 does not reveal the presence of a worker computer connection 104 or a worker computer 102 to the assignment computer connection from which the instruction 114 was received 126. Communications 800 to the assignment computer connection 106 from which the instruction 114 was received 126 may not reveal a presence of the one said worker computer connection 132 or a worker computer 102 corresponding to the one said assignment computer connection. A director computer 100 may communicate to the assignment computer connection 106 from which the instruction 114 was received 126 to not reveal a presence of the one said worker computer 132 connection or a worker computer 102 corresponding to the one said computer connection by, for example, changing the name of the worker in the response 136 received from the one said worker computer connection 132 before it is send to the one said computer connection. Another way for the director computer 100 to not reveal a presence of the one said worker computer 132 connection or a worker computer 102 is for the director computer 100 to use its own credentials to identify itself to assignment computer connections 106 rather than using credentials of the worker computer connections 104. Another way for the director computer 100 to not reveal a presence of the one said worker computer 132 connection or a worker computer 102 is for the director computer 100 to request instructions 114 with a difficulty that is different than the difficulty that would be requested by a worker computer 102 so that an assignment computer 108 sending an instruction 114 does not have information about the computational capacity of a worker computer 102 performing the instruction 114. Another way for the director computer 100 to not reveal a presence of the one said worker computer 132 connection or a worker computer 102 is to communicate with two or more assignment computer connections 106 for a worker computer 102, so that the assignment computer 108 may not infer the number of worker computers 102 based on the number of assignment computer connections 106.

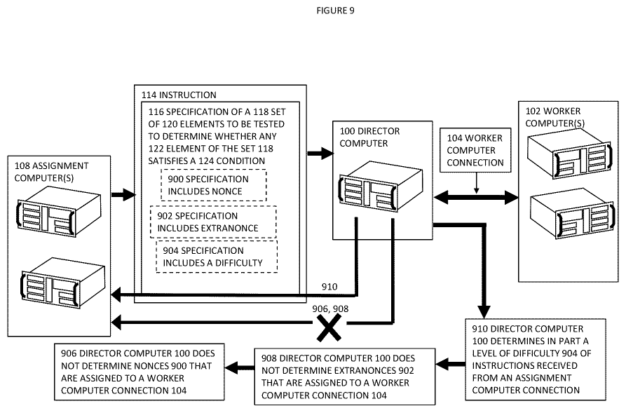

FIG. 9 is an illustration of an embodiment in which the director computer 100 may or may not determine in part the contents of an instruction 114 received from an assignment computer connection 106. An instruction 114 may include a specification 116 of a set 118 of elements 120 to be tested to determine whether any element 122 of the set 118 satisfies a condition 124. A specification 116 may include a nonce 900, an extranonce 902, or a difficulty 904. Operations may be performed such that the director computer 100 does not determine nonces 900 that are assigned to a worker computer connection 104 906. A director computer 100 may be able to not determine nonces 900 that are assigned to a worker computer connection 104 by not sending a request to the assignment computer connection 106 that the set 118 of elements 120 to be tested be constrained to particular nonces 900. Operations may be performed such that the director computer 100 does not determine extranonces 902 that are assigned to a worker computer connection 104 908. A director computer 100 may be able to not determine extranonces 902 that are assigned to a worker computer connection 104 by not sending a request to the assignment computer connection 106 that the set 118 of elements 120 to be tested be constrained to particular extranonces 902. Operations may be performed that include determining, by director computer 100, in part a level of difficulty of instructions 114 received from an assignment computer connection 106 910. A director computer 100 may be able to determine in part a level of difficulty of instructions 114 receives from an assignment computer connection 106 by sending to the assignment computer connection 106 a request for an assignment computer 108 to send instructions 114 with a desired difficulty.

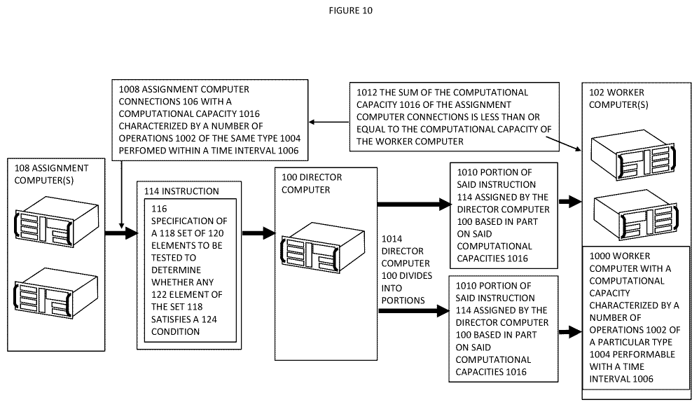

FIG. 10 is an illustration of an embodiment wherein the director computer 100 divides some of said instructions 114 into portions and performs assignment of the portions based on computational capacities. In this embodiment, some of said worker computer 1000 having a said computational capacity 1016 characterized by a number of operations 1002 of a particular type 1004 performable within a time interval 1006. Some of said assignment computer connection has a computational capacity 1008 characterized by a number of operations 1002 of the same type 1004 that may be performed within a time interval 1006, with the sum of the computational capacity 1012 of the assignment computer connections 106 being less than or equal to the computational capacity 616 of one said worker computer 1000, or many said worker computers 1000. The director computer 100 divides 614 some of said instructions 114 into portions 1010 and performs said assigning 130 based in part on said computational capacities 1016. The director computer 100 may maintain a record of the computational capacities 1016 of worker computers 1000 as well as any instructions 114 being performed on the worker computers 1000 and the utilized computational capacity 1016 of each instruction 114. The director computer 100 may use such records to determine the available computational capacity of each worker computer of the worker computers 1000. The director computer 100 may receive an instruction 114 from an assignment computer connection 106 which requires a computational capacity 1016 that is greater than the available computational capacity 1016 of one worker computer of the worker computers 1000, but less than the available computational capacity of the group of worker computers 1000. The instruction 114 may not be performed by only one worker computer of the group of worker computers 1000 as the computational capacity 1016 required by the instruction 114 exceeds the available computational capacity 1016 of any one worker computer of the group of worker computers 1000. The director computer 100 may divide the instruction 114 received from an assignment computer connection 106 into portions 1010, each portion 1010 of which is a new instruction 114 that does not exceed the available computational capacity 1016 of the worker computer 1000 the instruction 114 is assigned to. The portions 1010 are new instructions 114, each portion 1010 containing a specification 116 of a set 118 of elements 120 to be tested to determined whether any element 122 of the set 118 satisfied a condition 124. In addition, the portions 1010 may include other information that may be included in other instructions 114, for example, a difficulty. The director computer 100 may create portions 1010 requiring a particular computational capacity by changing the size of the set 118 of elements 120 to be tested in the specification 116, with a greater size of the set 118 of elements 120 corresponding to a greater required computational capacity required to test the set 118 of elements 120. The director computer 100 may distribute the computational capacity 1016 required to perform an instruction 114 over many portions 1010 by creating portions 1010 where the set of 118 elements 120 to be tested in each portion 1010 is a subset of the set 118 of elements 120 to be tested in the instruction 114 being divided into portions 1010, and generally the union of the sets of 118 elements 120 to be tested in the portions 1010 is equal to the set of 118 elements 120 to be tested in the instruction 114 being divided so that worker computers 1000 performing the portions 1010 test the same set 118 of elements 120 as the original instruction 114 that is divided. The director computer may create portions requiring a particular computational capacity by changing the difficulty of the instruction 114. The director computer 100 assigns these portions 1010 to worker computers 1000 to be performed, and may receive a response 136 from each of the worker computers 1000. The worker computer 1000 may receive the identities of any elements 122 of the set 118 that satisfies the condition 124 from the responses 136 from the worker computers 1000 and then send a response 136 to the assignment computer connection 106 from which the instruction 114 was received 128 the identifies of any elements 122 of the set 118 that satisfies the condition 124. The director computer 100 may send a response 136 to the assignment computer connection 106 from which the instruction 114 was received 128 that no elements 122 of the set 118 were identified that satisfies the condition 124 if the director computer 100 received no responses 136 that identified an element 122 of the set 118 that satisfies the condition 142. If the director computer 100 does not receive a response 136 from any of the worker computers 1000, the director computer 100 may indicate to the assignment computer connection 106 from which the instruction 114 was received 128 that no response was received 136.

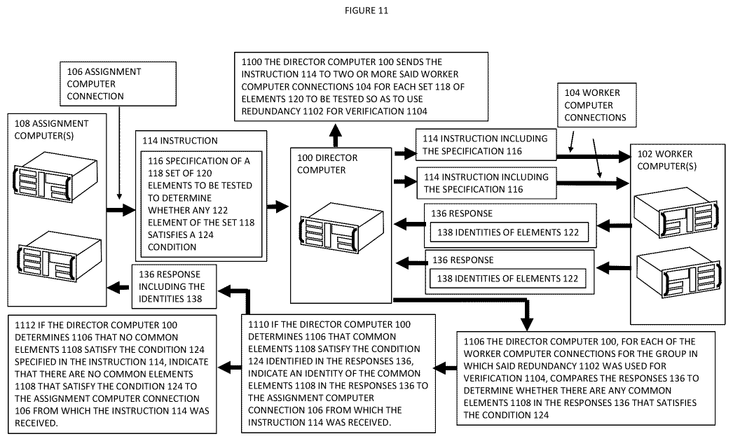

FIG. 11 is an illustration of an embodiment which employs redundancy to verify the responses 136 from worker computers 102. In this embodiment, the director computer 100 receives an instruction 114 from an assignment computer connection 106. The director computer 100 sends the instruction 114 to two or more said worker computer connections 104 for each set 118 of elements 120 to be tested as to use redundancy 1102 for verification 1104 1100. The director computer 100 may then receive responses 136 from each of the worker computer connections for the group in which said redundancy 1102 was used for verification 1104. For each of the worker computer connections 104 for the group in which said redundancy 1102 was used for verification 1104, the director computer 100 compares 1106 the responses 136 to determine whether there are any common elements 1108 in the responses that satisfy the condition 124 specified in the instruction 114. The common elements 1108 are those elements 122 that satisfy the condition 124 in each of the responses 136 that are present in all of the responses 136 received by the director computer 100 from the two or more said worker computer connections 104 for the group in which said redundancy was used for verification. If all of the responses 136 are in complete agreement, the responses 136 all contain identical sets 118 of elements 122 that satisfy the condition 124, and therefore each of the elements 122 that satisfy the condition 124 in each response 136 is also a common element 1108. If the director computer 100 determines 1110 that common elements 1108 satisfying the condition 124 have been identified in the responses 136, the director computer 100 indicates an identity of the common elements 1108 to the assignment computer connection 114 from which the instruction 114 was received 128. If the director computer 100 determines 1112 there are no common elements 1108 as satisfying the condition 124 identified in the responses 136, the director computer 100 may send a response 136 indicating that there are no common elements 1108 that satisfy the condition 124 to the assignment computer connection 106 from which the instruction was received. If there are responses that are not in agreement, for example, if one response 136 contains one or more elements 122 that another response 136 does not contain, the director computer 100 may send a response 136 to the assignment computer connection 106 from which the instruction was received 114 that identifies the differences in the elements 122 communicated in two or more responses 136 to the director computer 100 from the worker computer connections 104 for the group in which said redundancy was used for verification. If the director computer 100 does not receive responses 136 from worker computer connections 104 for the group in which said redundancy was used for verification, the director computer 100 may send a response 136 to the assignment computer connection 106 from which the instruction was received 114 that indicates that responses 136 were not received from worker computer connections 104.

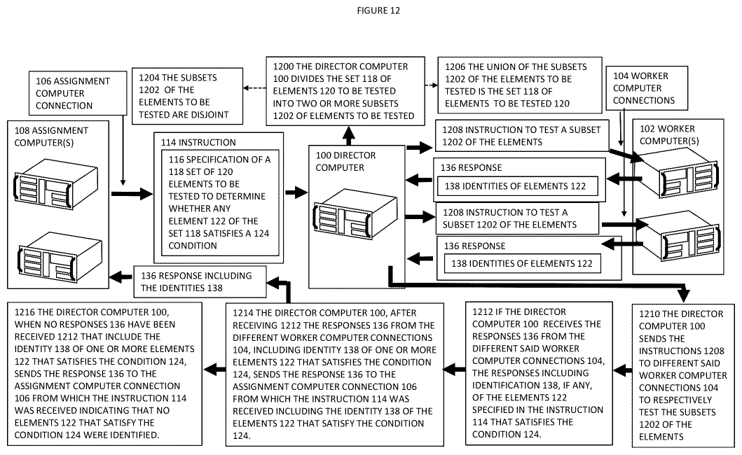

FIG. 12 is an illustration of an embodiment in which the director computer 100 divides the set 118 of elements 120 to be tested into two or more subsets 1202 of elements 120 to be tested. A director computer 100 may receive an instruction 114 from an assignment computer connection 106 and the instruction 114 may include a specification 116 of a set 118 of elements 120 to be tested to determine whether any element 122 of the set 118 satisfies a condition 114. The director computer 100 may divide the set 118 of elements 120 to be tested into two or more subsets 1202 of elements to be tested 1200. All of the elements of a subset 1202 of elements to be tested 1200 are also members of the set 118 of elements 120 to be tested in the specification 116 of the instruction 114 received from the assignment computer connection 116. The director computer 100 may divide the set 118 of elements 120 into subsets 1202 of the elements to be tested with the subsets 1202 being disjoint 1204, or in other words, with any subset 1202 not having a common element with any other subset 1202. The director computer 100 may divide the set 118 of elements 120 to be tested into subsets 1202 of the elements to be tested with the union 1206 of the subsets 1202 being the same set as the set 118 of elements 120 to be tested in the specification 116 of the instruction 114 received from the assignment computer connection 106. The director computer 100 can create an instruction 114 to test a subset 1202 of the elements 1208, where the specification 116 of each set 118 of elements 120 to be tested in each instruction 1208 that is created is one of the subsets 1202 of elements 122 to be tested. The instruction 1208 that is created for each subset 1202 may have a specification 116 of its respective set 118 of elements 120 to be tested that may be performed by a particular respective worker computer 102. The director computer 100 may send 1210 the instructions 1208 to different said worker computer connections 104 respectively to test the subsets 1202 of the elements. The director computer 100 may divide the set 118 of elements 120 to be tested received in the instruction 114 from the assignment computer connection 106 into subsets 1202, and create one or more instructions 1208 with a specification 116 of a set 118 of elements 120 to be tested including subsets 1202, so that the size of each subset 1202 is suitable so that each instruction 1208 may be performed on a respective worker computer 102 with a particular computational capacity. The director computer 100 can then divide up the required computational capacity that would be required for an instruction 114 received from an assignment computer connection 106 into two or more instructions 1208 that each may be performed on a worker computer 102 of a lesser computational capacity than would be required to perform the instruction 114 received from the assignment computer connection 106. The director computer 100 may receive 1212 responses 136 from the said worker computer connections 104, the responses 136 including identification, if any, of the elements 122 specified in the instruction 1208 that satisfies the condition 124. The director computer 100, after receiving 1212 the responses 136 from different worker computer connections 104, including identity of one or more elements 122 that satisfies the condition 124, the director computer sends 1214 the response 136 to the assignment computer connection 106 from which the instruction was received 128 including the identity of the elements 122 that satisfy the condition 124. The director computer 100 may receive 1212 two or more responses 136 from worker computer connections 104 which each may identify elements 122 that satisfy the condition 124. In this case, the director computer 100 may send 1214 to the assignment computer connection 106 from which the instruction was received 128 a response 136 which includes the identity of all of the elements 122 that satisfy the condition 124 that were received 128, if any elements 122 that satisfy the condition 124 were received, from the worker computer connections 104. The director computer 100, if it receives 1216 no responses 136 that include the identity of one or more elements 122 that satisfies the condition 124, may send a response 136 to the assignment computer connection 106 from which the instruction 114 was received 128 indicating that no elements 122 that satisfy the condition 124 were identified.

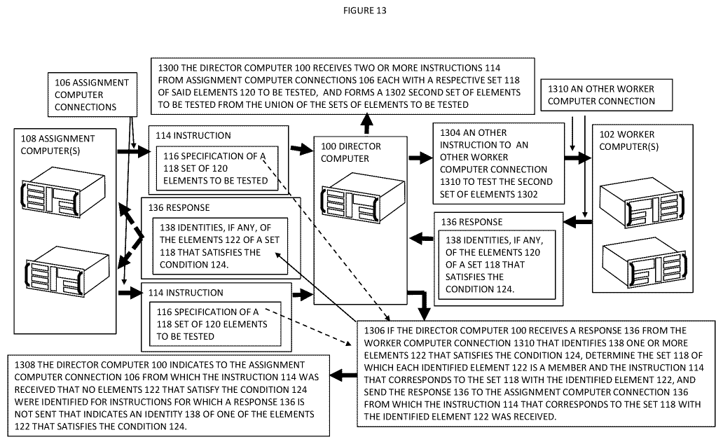

FIG. 13 is an illustration of an embodiment in which the director computer 100 combines two or more instructions 114 received from assignment computer connections 106 into an instruction 114. A director computer 100 may receive 1300 two or more instructions 114 from said assignment computer connections 106 each with a respective set 118 of said elements 120 to be tested. The director computer 100 may form a second set of elements 1302 to be tested from the union of the sets 118 of elements 120 to be tested in the respective specifications 116 of the instructions 114 received from said assignment computer connections 106. The director computer 100 may form an other instruction 1304 with a specification 116 of a set 118 of elements 120 to be tested that is the second set of elements 1302 to be tested. The second set 1302 of elements 120 to be tested included in the specification 116 of the other instruction 1304 may be a size selected by the director computer 100 so that it may be performed using the computational capacity of a particular worker computer 102. The director computer 100 may send the other instruction 1304 to an other worker computer connection 1310 to test the second set of elements 1302. The director computer 100 may send the other instruction 1304 to a worker computer connection 104 to communicate the other instruction 1304 to a worker computer 102 via the other worker computer connection 1310 with the computational capacity to perform the other instruction 1304. The director computer 100 may receive 1306 a response 136 from the worker computer connection 1310 that identifies one or more elements 122 that satisfies the condition 124. The director computer 100 then may determine the set 118 of which each identified element 122 is a member and the instruction 114 that corresponds to the set with the identified element 122. Each element 122 that satisfies the condition 124 in the response 136 from the worker computer connection 104 is a member of at least one of the respective sets 118 of elements 120 in the instructions 114 received by the director computer 100 from the assignment computer connections 106. The director computer 100 identifies the set 118 that each element 122 that satisfies the condition 124 is a member of, the corresponding instruction 114 that the set 118 is specified 116 in, and the corresponding assignment computer connection 106 from which the corresponding instruction 114 was received by the director computer 100. The director computer 100 may then send the response 136 to the assignment computer connection 106 from which the instruction 114 the corresponds to the set 118 with the identified element 122 was received. The response 136 to the assignment computer connection 106 that indicates the identity of the element 122 that satisfies the condition 124. If the director computer 100 does not send 1308 a response 136 to an instruction 114 that indicates an identity of one of the elements 122 that satisfies the condition 124, the director computer 100 may indicate to the assignment computer connection 106 from which the instruction was received 128 that no elements 122 that satisfy the condition 124 were identified.

An example of the embodiment is that a director computer 100 receives 1300 two instructions 114 from assignment computer connections 106 to mine cryptocurrency using a test of cryptographic hashes, the first of the instructions 114 with a specification of a set 118 of elements 120 that requires a 50 terahashes per second computational capacity, and the second of the instructions 114 with a specification of a set 118 of elements 118 that requires 30 terahashes per second computational capacity. The director computer 100 may create a new instruction 1304 forms a second set of elements 1302 from the union of the sets 118 from these two instructions 114 that requires the sum of computational capacity of the two sets 118, or 80 terahashes per second. The director computer 100 then sends the instruction 1304 to a worker computer connection 1310 with the computational capacity to perform the instruction 1304. The director computer 100 may receive 1306 a response 136 with the identity of an element 122 that satisfy the condition 124. The director computer 100 may determine that the set 118 in the specification 116 in the instruction 114 received from first assignment computer connection 106 contains the element 122 that satisfies the condition 124, and the director computer 100 may then send a response to the first assignment computer connection 106 with the identity of the element 122 that satisfies the condition 124. The director computer 100 may also send a response 136 to the second assignment computer connection 106 to indicate that no elements 122 were identified that satisfy the condition 124.

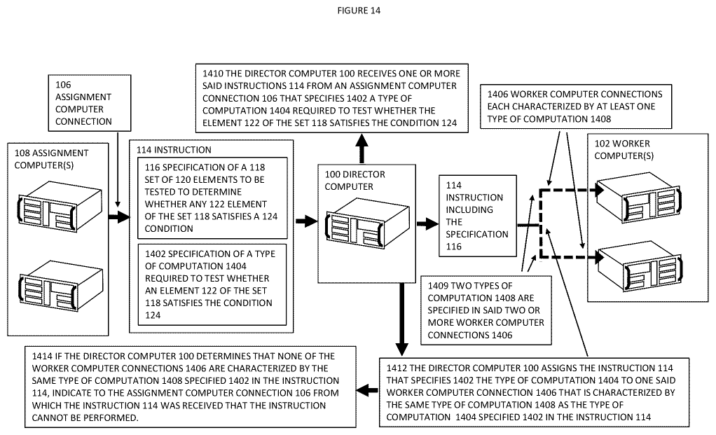

FIG. 14 is an illustration of an embodiment which includes two worker computer connections each characterized by at least one type of computation. Two or more worker computer connections 104 are characterized 1406 by at least one type of computation 1404. A type of computation 1404 may be, for example, a particular computation required to determine if elements 120 satisfy a condition 124. For example, a cryptographic hash type of computation 1404 may characterize a worker computer 102 that may perform cryptographic hash operations. A graphics processing unit type of computation 1408 may characterize a worker computer 102 that may perform computations with a graphics processing unit, and the type of computation 1404 may be further specialized to graphics processing units of particular vendors or particular models of graphics processing unit. A protein folding simulation type of computation 1404 may characterize a worker computer 102 that is able to perform protein folding simulations. A N-body dynamics simulation type of computation 1404 may characterize a worker computer 102 that is able to perform an N-body dynamics simulation. A worker computer connection 104 may be characterized by a type of computation 1404 that a worker computer 102 that receives instructions 114 from a director computer 100 via the worker computer connection 104 is capable of performing. Two or more types of computation 1409 are specified 1010 in said two or more worker computer connections 1406. A director computer 100 may receive 1410 one or more said instructions 114 from an assignment computer connection 106 that specifies 1402 a type of computation 1404 required to test whether the element 120 of the set 118 satisfies the condition 124. The director computer 100 may assign 1412 the instruction 114 that specifies 1402 the type of computation 1004 to one said worker computer connection 1406 that is characterized by the same type of computation 1404 specified in the instruction 114. For example, if an instruction 114 specifies a type of computation 1404 that is a cryptographic hash type of computation, and there are two worker computer connections 104, one of which is characterized by a graphics processing unit type of computation, and the other of which is characterized by a cryptographic hash type of computation, the director computer 100 may assign the instruction 114 to the worker computer connection 104 that is characterized by the cryptographic hash type of computation, as that is the same type of computation 1404 specified in the instruction 114. If the director computer 100 determines that none of the worker computer connections 104 are characterized by the same type of computation 1404 that is specified in the instruction 114, then the director computer 100 may indicate to the assignment computer connection 106 from which the instruction 114 was received 128 that the instruction 114 cannot be performed.

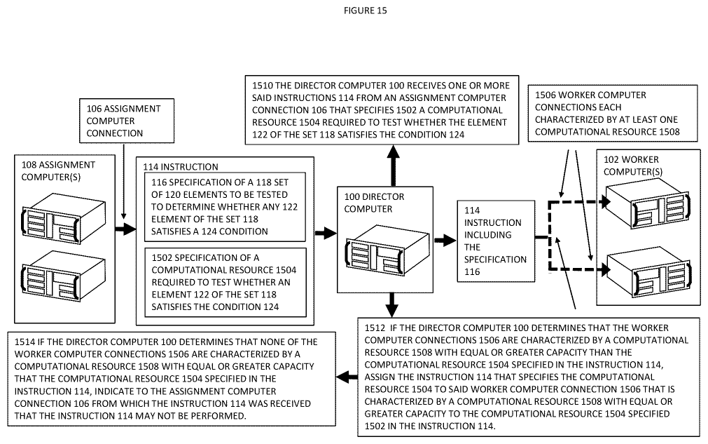

FIG. 15 is an illustration of an embodiment which includes two worker computer connections 104 each characterized by at least one computational resource. Two or more worker computer connections are each characterized 1506 by at least one computational resource 1508. A worker computer 102 can be characterized by a particular computational resource 1504 in order to perform an instruction 114 to test whether an element 122 of a set 118 satisfies a condition 124 that specifies 1502 the computational resource 1504 is required. For example, a worker computer 102 may be characterized by one or more computational resources 1508 that are physical hardware, for example, a particular application specific integrated circuit, cryptographic hashing integrated circuit, graphics processing unit, central processing unit, a requisite amount of random-access memory, a requisite amount of nonvolatile storage, particular network interfaces, connections to particular networks, etc. A worker computer 102 may be characterized by one or more computational resources 1508 that is particular software, for example, a particular operating system, particular software needed to operate hardware, particular custom software required to perform an instruction 114, etc. A worker computer connection 104 may be characterized by a computational resource 1504 of a worker computer 102 that receives instructions 114 from a director computer 100 via the worker computer connection 104. For computational resources 1504 that are quantified, for example, a cryptographic hash hardware that is characterized by a certain number of cryptographic hashes per second, or a number of central processing units, one may determine if a worker computer connection 104 has computational resources 1504 of equal or greater capacity to the computational resources 1504 specified 1502 in the instruction 114. For quantified computational resources, a director computer 100 can compare each computational resource 1504 specified 1502 in the instruction 114 with the computational resource 1504 that a worker computer connection 104 is characterized by, and if the quantity of the computational resource 1504 the worker computer connection is characterized by is greater than or equal to the corresponding computation resource 1504 specified 1502 in the instruction 114, the computational resource 1504 of the worker computer connection 104 has an equal or greater capacity than the computational resources 1504 specified 1502 in the instruction 114. As one, but not the only, example—for computational resources 1504 that are simply present or not present and not quantified, a director computer 100 can determine if a worker computer connection 104 has an equal or greater capacity than the computational resources 1504 specified 1502 in the instruction 114 by checking if a worker computer connection 1504 is characterized by each non-quantifiable computational resource 1504 that is specified 1502 in the instruction 114, and only if the worker computer connection 114 is characterized by each computational resource 1504 that is specified in the instruction 114, does the worker computer connection 104 have an equal or greater capacity. If both quantifiable and non-quantifiable computational resources 1504 are specified 1502 in the instruction 114, the worker computer connection 114 must have equal or greater capacity of both quantifiable and non-quantifiable computational resources 1504 in order to have equal or greater capacity of all computational resources 1504 specified 1502 in the instruction 114. A director computer 100 may receive 1510 one or more said instructions 114 from an assignment computer connection 106 that specifies 1502 a computation resource 1504 required to test whether an element 122 of the set 118 satisfies the condition 124. If the director computer 100 determines 1512 that the worker computer connections 1506 are characterized by computational resources with equal or greater capacity than the computational resource 1504 specified 1502 in the instruction 114, the director computer 100 may assign the instruction 114 that specifies the computational resource 1504 to said worker computer connection 132 that is characterized by a computational resource 1504 with equal or greater capacity to the computational resource 1504 specified 1502 in the instruction 114. If the director computer 100 determines 1514 that none of the worker computer connections 1506 are characterized by computational resources 1104 with equal or greater capacity than the computational resource 1504 specified 1502 in the instruction 114, the director computer 100 may indicate to the assignment computer connection 106 from which the instruction 114 was received 128 that the instruction 114 may not be performed.

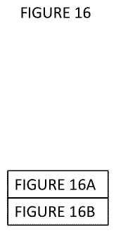

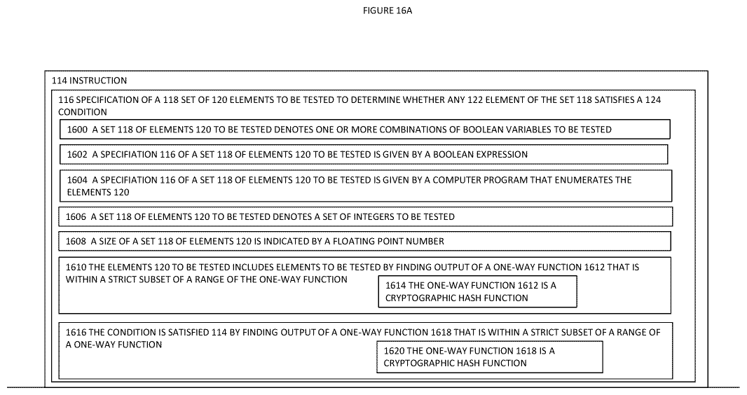

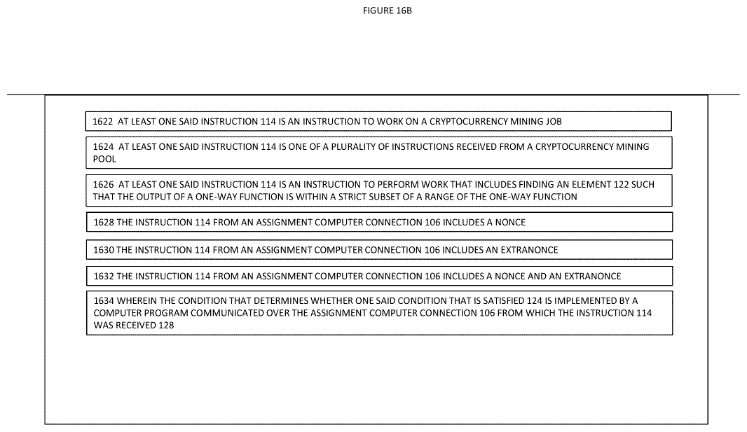

FIG. 16 is an illustration of embodiments of an instruction 114. The specification 116 of a set 118 of elements 120 to be tested to determine whether any element 122 of the set 118 satisfies a condition 124 may be specifies in many ways. For example, a specification 116 of a set 118 of elements 120 to be tested may denote one or more combinations of Boolean variables to be tested 1600. An element 120 of a set 118 to test may be a particular combination of true or false states for Boolean variables in a Boolean expression. A specification of a set 118 of elements 120 to be tested 120 may be a subset of the possible states of Boolean variables that may be tested. A specification 116 of a set of 118 of elements 120 to be tested may be given by a Boolean expression 1602. The combinations of true or false states for Boolean variables to be tested may be those combinations for which a specified 116 Boolean expression is true. A specification 116 of a set 118 of elements 120 to be tested may be given by a computer program that enumerates the elements 120 1604. The computer program may be a generator program or a closure program which, each time it is executed, outputs an element 120 of the set 118 to be tested. The computer program may be communicated over the assignment computer connection 106, or the identity of the computer program may be communicated over the assignment computer connection 106, along with any other parameters needed for the computer program. A specification 116 of a set 118 of elements 120 to be tested may be denoted by a set of integers to be tested 1606. Nonces and extranonces, for example, are integers, and the nonces and extranonces to be tested can be specified as a set of integers. A specification 116 of the size of a of a set 118 of elements 120 to be tested may be indicated by a floating-point number 1608. For example, a binary floating-point number may have an exponent that determines the binary shift or digit placement of a maximum or minimum integer value of the set of integers, and the mantissa of the binary floating-point number determines the maximum or minimum integer value of the set of integers. An instruction 114 may specify 116 elements 120 to be tested that includes elements to be tested by finding an output of a one-way function 1612 that is within a strict subset of a range of the one-way function 1610. An example of this is an instruction 114 that specifies 116 nonce and/or extranonce elements 120 to be tested to determine if when the elements are transformed by a cryptographic hash function, the resulting hash values have a particular property, for example, are within a subset of the possible hash values such as having the hash value less than a target number. The one-way function 1612 may be a cryptographic hash function 1614. An instruction may specify 116 that the condition is satisfied 124 by finding an output of a one-way function that is within a strict subset of a range of a one-way function. An example of this is an instruction 114 that specifies 116 that the condition to be satisfied 124 is that an element 120 is to be transformed by a cryptographic hash function and that the resulting hash value satisfies the condition that it is less than a target number. The one-way function 1618 may be a cryptographic hash function 1620.

At least one said instruction 114 may be an instruction to work on a cryptocurrency mining job 1622. A cryptocurrency mining job may be an instruction 114 that is performed on a cryptocurrency miner and an instruction to work on a cryptocurrency mining job may be obtained from an assignment computer connection 106 to a cryptocurrency mining pool. At least one said instruction 114 is one of a plurality of instructions 114 received from a cryptocurrency mining pool 1624. A plurality of instructions 114 may be received from a cryptocurrency mining pool by connecting to a cryptocurrency mining pool with an assignment computer connection and issuing commands, for example Stratum protocol commands, to instruct the cryptocurrency mining pool to send instructions 114, for example to mine cryptocurrency. At least one said instruction 114 may be an instruction to perform work that includes finding an element 122 such that the output of a one-way function is within a strict subset of a range of a one-way function 1626. One instruction 114 to perform such work is a instruction 114 to mine cryptocurrency, which tests elements 120 which are nonces and extranonces with a cryptographic hash function that is a one-way function so that the resulting hash value is within a strict subset of the range of the one-way function by being satisfying a condition 124 when the hash value is less than or equal to a certain target integer. An instruction 114 from an assignment computer connection 106 may include a nonce 1628. An instruction 114 from an assignment computer connection 106 may include an extranonce 1630. An instruction 114 from an assignment computer connection 106 may include a nonce and an extranonce 1632. An instruction 114 from an assignment computer connection 106 to an assignment computer 108 that is a cryptocurrency mining pool can assign instructions 114 that includes a nonce, extranonce, or both, particularly if the assignment computer connection 106 is conducted using the Stratum protocol. An instruction 114 may specify 116 a condition that determines whether the one said condition is satisfied 124 that is implemented by a computer program communicated over the assignment computer connection 106 from which the instruction 114 was received 128 1634. An instruction 114 may specify a condition by communicating a program over the assignment computer connection 106, for example in a computer language like C or Python, or a specialized language, that takes an element and other necessary parameters to test for the condition as arguments and returns a result that indicates whether the element satisfies or does not satisfy the condition. The director computer 100 may relay the computer program to a worker computer connection 104. A worker computer 102 that performs the instruction 114 executes the program communicated over the assignment computer connection 106 with each element as an argument, and if it finds an element 122 that the program indicates satisfies the test, returns a response 136 with the identity of the element 122.

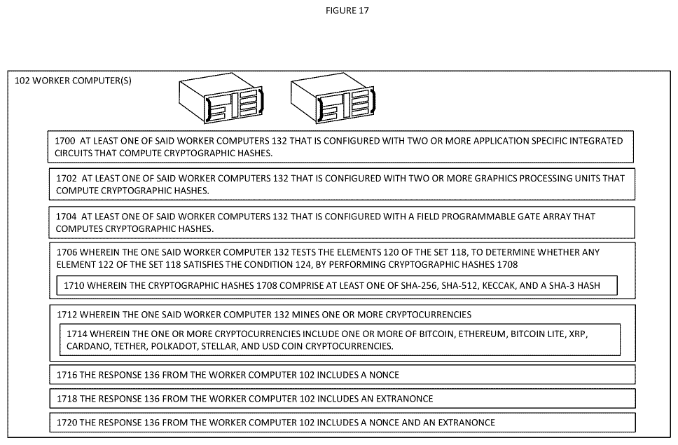

FIG. 17 is an illustration of embodiments of one or more worker computers 102. At least one of said worker computers 132 may be configured with two or more application specific integrated circuits that compute cryptographic hashes 1700. An example of a worker computer 102 that is configured with two or more application specific integrated circuits that configure cryptographic hashes would be a worker computer 102 that is a cryptocurrency miner. At least one of said worker computers 132 may be configured with two or more graphics processing units that compute cryptographic hashes 1702. An example of a worker computer 102 that is configured with two or more graphics processing units that compute cryptographic hashes is a commodity hardware computer that includes two graphics processing units, for example, two graphics processing units from NVIDIA or AMD, each of the graphics processing units programmed to perform cryptographic hashes. At least one of said worker computers 172 may be configured a field programmable gate array that computes cryptographic hashes 1704. An example of a worker computer 102 that is configured with a field programmable gate array that computes cryptographic hashes 1704 is a commodity hardware computer includes a field programmable gate array, for example a field programmable gate array from Intel, Altera, or Lattice Semiconductor, with the field programmable gate array programmed with reconfigurable logic or an intellectual property core that computes cryptographic hashes. A one said worker computer 132 may test 1706 the elements 120 of the set 118 to determine whether any element 122 of the set 118 satisfies the condition 124 by performing cryptographic hashes 1708. An example of one said worker computer 132 testing 1706 whether an element 120 of a set 118 to determine whether any element 122 of the set 118 satisfies the condition 124 by performing cryptographic hashes 1708 is a worker computer 132 performing a cryptocurrency mining task that performs cryptographic hashes to elements that may be nonces and/or extranonces to find a hash value that is less than a particular target value. The cryptographic hashes 1708 may be comprised at least one of a SHA-256, SHA-512, KECCAK, or SHA-3 cryptographic hash 1710. A one said worker computer 132 may mine one or more cryptocurrencies 1712. The one or more cryptocurrencies may include one or more of Bitcoin, Ethereum, Bitcoin Lite, XRP, Cardano, Tether, Polkadot, Stellar, and USD Coin cryptocurrencies 1714. A response 136 from the worker computer 102 may include a nonce 1716. A response from the worker computer 102 may include an extranonce 1718. A response for the worker computer 102 may include a nonce and an extranonce 102 1720. A response 136 from a worker computer may include a nonce, extranonce, or both a nonce and an extranonce if the worker computer 102 is mining a cryptocurrency, for example a cryptocurrency such as Bitcoin, or if the worker computer 102 is communicating via a worker computer connection 104 using the Stratum protocol.

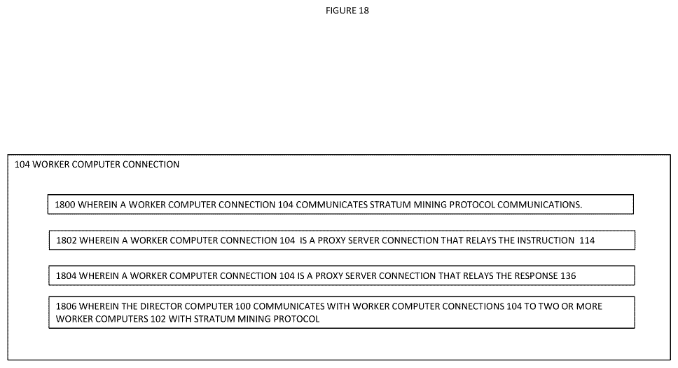

FIG. 18 is an illustration of embodiments of a worker computer connection 104. A worker computer connection 104 may communicate Stratum mining protocol communications 1800. A worker computer connection 104 may communicate Stratum mining protocol communications with a director computer 100 that is communicating with an assignment computer connection 106 to cryptocurrency mining pool that sends instructions 114 as Stratum mining protocol communications, for example instructions 114 for a cryptocurrency miner to mine a cryptocurrency such as Bitcoin. A worker computer connection 104 may be a proxy server connection that relays the instruction 114 1802. A worker computer connection 104 may be a proxy server connection that relays the instruction 114, for example, if the worker computer connection 104 is communicating with another director computer 100 acting as a proxy server, or if the worker computer connection 104 is communicating with an other computer performing as a proxy server, for example a Stratum mining proxy if the Stratum protocol is used to communicate via the worker computer connection 104. A worker computer connection 104 may be a proxy server connection that relays the response 136 1804. A worker computer connection 104 may be a proxy server connection that relays the response 136, for example, if the worker computer connection 104 is communicating with another director computer 100 acting as a proxy server, or if the worker computer connection 104 is communicating with an other computer program as a proxy server, for example, a Stratum mining proxy if the Stratum protocol is used to communicate via the worker computer connection 104. One or more worker computer connections 104 may be configured such that the director computer 100 communicates with worker computer connections 104 to two or more worker computers 102 with Stratum mining protocol 1806.

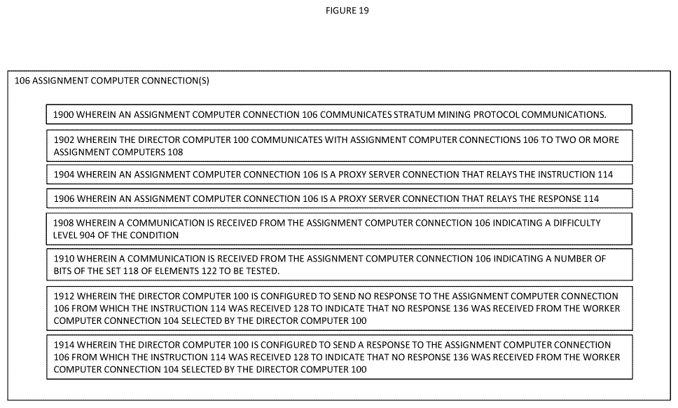

FIG. 19 is an illustration of embodiments of one or more assignment computer connections. An assignment computer connection 106 may communicate Stratum mining protocol communications 1900. An assignment computer connection 106 may communicate Stratum mining protocol communications if the director computer 100 is communicating via an assignment computer connection 106 to a cryptocurrency mining pool that issues instructions 114 using the Stratum mining protocol. One or more assignment computer connections 106 may be configured such that the director computer 100 communicates with assignment computer connections 106 to two or more assignment computers 108 1902. An assignment computer connection 106 may be a proxy server connection that relays the instruction 114 1904. An assignment computer connection 106 may be a proxy server connection that relays the instruction 114, for example, if the assignment computer connection 106 is communicating with another director computer 100 acting as a proxy server, or if the assignment computer connection 106 is communicating with an other computer performing as a proxy server, for example a Stratum mining proxy if the Stratum protocol is used to communicate via the assignment computer connection 106. An assignment computer connection 106 may be a proxy server connection that relays the response 136 1906. An assignment computer connection 106 may be a proxy server connection that relays the response 136, for example, if the assignment computer connection 106 is communicating with another director computer 100 acting as a proxy server, or if the assignment computer connection 106 is communicating with an other computer program as a proxy server, for example, a Stratum mining proxy if the Stratum protocol is used to communicate via the assignment computer connection 106. A director computer 100 may receive a communication from the assignment computer connection 106 indicating a difficulty level 504 of the condition 1908. A communication from the assignment computer connection 106 indicating a difficulty level 504 of the condition 1908 may be a Stratum protocol message that sets the difficulty, the difficulty indicating the permitted hash values resulting from the cryptographic hash operation that satisfy the condition 124. A director computer 100 may receive a communication from the assignment computer connection 106 indicating a number of bits of the set 118 of elements 122 to be tested 1910.

A communication from the assignment computer connection 106 indicating a number of bits of the 118 of elements to be tested 1910 may be a Stratum protocol message that sets an extranonce, for example one that sets the size of an extranonce2 field which indicates the number of bits the cryptocurrency miner may add to the extranonce in order to obtain a hash value that satisfies the condition 124. A director computer 100 may be configured to send no response to the assignment computer connection 106 from which the instruction was received 128 to indicate that no response 136 was received from the worker computer connection 104 selected by the director computer 100 1912. A director computer 100 may be configured to send a response to the assignment computer connection 106 from which the instruction was received 128 to indicate that no response 136 was received from the worker computer connection 104 selected by the director computer 100 1914. The director computer 100 may be configured to either send no response 136 to the assignment computer connection 106, or send a response 136 to the assignment computer connection 106 from which the instruction was received 128 to indicate that no response 136 was received from the worker computer connection 104 selected by the director computer 100, with the configuration determined by whether an assignment computer 108 expects or requires a response 136 to an instruction 114, e.g., whether a response 136 must be received by the assignment computer 108 before the assignment computer 108 may send another instruction 114.

In sum, it is important to recognize that this disclosure has been written as a thorough teaching rather than as a narrow dictate or disclaimer. Reference throughout this specification to “one embodiment”, “an embodiment”, or “a specific embodiment” means that a particular feature, structure, or characteristic described in connection with the embodiment is included in at least one embodiment and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other embodiments. It is to be understood that other variations and modifications of the embodiments described and illustrated herein are possible in light of the teachings herein and are to be considered as part of the spirit and scope of the present subject matter.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise. Variation from amounts specified in this teaching can be “about” or “substantially,” so as to accommodate tolerance for such as acceptable manufacturing tolerances.

The foregoing description of illustrated embodiments, including what is described in the Abstract and the Modes, and all disclosure and the implicated industrial applicability, are not intended to be exhaustive or to limit the subject matter to the precise forms disclosed herein. While specific embodiments of, and examples for, the subject matter are described herein for teaching-by-illustration purposes only, various equivalent modifications are possible within the spirit and scope of the present subject matter, as those skilled in the relevant art will recognize and appreciate. As indicated, these modifications may be made in light of the foregoing description of illustrated embodiments and are to be included, again, within the true spirit and scope of the subject matter disclosed herein.

I/We claim:

1. A dynamically configurable network architecture apparatus, the apparatus comprising:
a director computer configured to:
communicate via Y worker computer connections, such that Y≥2, to two or more worker computers, with at least one worker computer connection to each worker computer;
communicate via X assignment computer connections, such that X≥Y+2, to a group of one or more assignment computers;
communicate such that for each instruction received from each said assignment computer connection, the instruction including a specification of a set of elements to be tested to determine whether any element of the set satisfies a condition:
assign the instruction to one said worker computer connection;
send the instruction to the one said worker computer connection; and
if a response is received from the one said worker computer connection, the response including identification, if any, of the elements specified in the instruction that satisfies the condition, then send the response to the assignment computer connection from which the instruction was received; and
if the response is not received from the one said worker computer connection, then indicate to the assignment computer connection from which the instruction was received that no response was received.

2. The apparatus of claim 1, wherein the director computer is a first director computer, and further including Z connection layers, such that Z≥1, interposed between one said worker computer and the first director computer, wherein a second director computer interposed at one said layer receives instructions from the first director computer, sends instructions to the one said worker computer, receives responses from the one said worker computer, and sends responses to the first director computer.

3. The apparatus of claim 1, wherein the director computer is a first director computer, and further including Z connection layers, such that Z≥1, interposed between the one said worker computer and the first director computer, wherein the first director computer selects one of two or more redundant director computers interposed at one said layer to send the instruction to said one of two or more redundant director computers.

4. The apparatus of claim 1, wherein:
at least some of said worker computers have a computational capacity characterized by a number of operations of a particular type performable within a time interval, and
at least some of said assignment computer connections have a computational capacity characterized by a number of operations of the same type that may be performed within a time interval.

5. The apparatus of claim 1, wherein the director computer is configured to:
receive two or more instructions from said assignment computer connections, each of the two or more instructions having a respective set of said elements to be tested, and
form a second set of elements to be tested from a union of the sets of elements to be tested, and
send an other instruction to an other said worker computer connection to test the second set of elements, and
if a response is received from the worker computer connection that identifies one or more elements that satisfies the condition, determine the set of which of the sets of elements each identified element is a member, and the instruction that corresponds to the set with the identified element, and send the response to the assignment computer connection from which the instruction that corresponds to the set of the sets of elements with the identified element was received, and
for instructions for which a response is not received that indicates an identity of one of the elements that satisfies the condition, indicate to the assignment computer connection from which the instruction was received that no elements that satisfy the condition were identified.

6. The apparatus of claim 1, wherein:
two or more said worker computer connections are each characterized by at least one type of computation the two or more types of computation are specified in said two or more worker computer connections, and
the director computer is configured to:
receive one or more of said instructions from an assignment computer connection that specifies a type of computation required to test whether an element of the set satisfies the condition, assign the instruction that specifies the type of computation to one said worker computer connection that is characterized by the same type of computation as the type of computation specified in the instruction that that specifies a type of computation, and
if none of the worker computer connections are characterized by the same type of computation that is the type of computation specified in the instruction, indicate to the assignment computer connection from which the instruction that specifies the type of computation was received that the instruction cannot be performed.

7. The apparatus of claim 1, wherein:
two or more said worker computer connections are each characterized by at least one computational resource, the director computer is configured to receive one or more said instructions from one said assignment computer connection that specifies a computational resource required to test whether an element of the set satisfies the condition, and
the director computer is configured such that:
if the worker computer connections are characterized by a computational resource with equal or greater capacity than the computational resource specified in the instruction, assign the instruction that specifies the computational resource to said worker computer connection that is characterized by a computational resource with equal or greater capacity than the computational resource specified in the instruction, and
if none of the worker computer connections are characterized by a computational resource with equal or greater capacity than the computational resource specified in the instruction, indicate to the assignment computer connection from which the instruction was received that the instruction may not be performed.

8. A process of making a network architecture, the process comprising:
configuring a network architecture, including:
interconnecting a director computer to communicate via Y worker computer connections, such that Y≥2, to two or more worker computers, with at least one worker computer connection to each worker computer;
interconnecting the director computer to communicate via X assignment computer connections, such that X≥Y+2, to a group of one or more assignment computers;
configuring the director computer to communicate such that for each instruction received from each said assignment computer connection, the instruction including a specification of a set of elements to be tested to determine whether any element of the set satisfies a condition, the director computer:
assigns the instruction to one said worker computer connection;
sends the instruction to the one said worker computer connection; and
if a response is received by the director computer from the one said worker computer connection, the response including identification, if any, of the elements specified in the instruction that satisfies the condition, then the director computer sends the response to the assignment computer connection from which the instruction was received; and
if the response is not received by the director computer from the one said worker computer connection, then by the director computer indicates to the assignment computer connection from which the instruction was received that no response was received.

9. The process of claim 8, wherein the director computer is a first director computer, and further including interposing Z connection layers, such that Z≥1, between one said worker computer and the first director computer, and interposing a second director computer at one said layer, and configuring the second director computer to receive instructions from the first director computer, send instructions to the one said worker computer, receive responses from the one said worker computer, and send responses to the first director computer.

10. The process of claim 8, wherein configuring the network architecture includes configuring the network architecture such that:
at least some of said worker computers have a computational capacity characterized by a number of operations of a particular type performable within a time interval, and at least some of said assignment computer connections have a computational capacity characterized by a number of operations of the same type that may be performed within a time interval.

11. The process of claim 10, wherein:
for at least one of said group, a sum of the computational capacity of the assignment computer connections is less than or equal to the computational capacity of the worker computer, and
wherein the configuring the director computer includes configuring the director computer to divide some of said instructions into portions and assigned based on said computational capacity.

12. The process of claim 8, wherein the configuring the director computer includes configuring the director computer to:
receive two or more instructions from said assignment computer connections each with a respective set of said elements to be tested, and
form a second set of elements to be tested from a union of the sets of elements to be tested, and
send an other instruction to an other said worker computer connection to test the second set of elements, and
if a response is received from the worker computer connection that identifies one or more elements that satisfies the condition, determine the set of which each identified element is a member and the instruction that corresponds to the set with the identified element, and send the response to the assignment computer connection from which the instruction that corresponds to the set with the identified element was received, and
for instructions for which a response is not sent that indicates an identity of one of the elements that satisfies the condition, indicate to the assignment computer connection from which the instruction was received that no elements that satisfy the condition were identified.

13. The process of claim 8, wherein:
two or more said worker computer connections are each characterized by at least one type of computation, the two or more types of computation are specified in said two or more worker computer connections, and
the configuring the director computer includes configuring the director computer to:
receive one or more of said instructions from an assignment computer connection that specifies a type of computation required to test whether an element of the set satisfies the condition, assign the instruction that specifies the type of computation to one said worker computer connection that is characterized by the same type of computation as the type of computation specified in the instruction, and if none of the worker computer connections are characterized by the same type of computation that is the type of computation specified in the instruction that instruction that specifies a type of computation, indicate to the assignment computer connection from which the instruction was received that the instruction that instruction that specifies the type of computation cannot be performed.

14. The process of claim 8, wherein:
two or more said worker computer connections are each characterized by at least one computational resource, the director computer receives one or more said instructions from one said assignment computer connection that specifies a computational resource required to test whether an element of the set satisfies the condition, and
the configuring the director computer includes configuring the director computer such that:
if the worker computer connections are characterized by a computational resource with equal or greater capacity than the computational resource specified in the instruction, assign the instruction that specifies the computational resource to said worker computer connection that is characterized by a computational resource with equal or greater capacity than the computational resource specified in the instruction, and
if none of the worker computer connections are characterized by a computational resource with equal or greater capacity than the computational resource specified in the instruction, indicate to the assignment computer connection from which the instruction was received that the instruction may not be performed.

15. A process comprising:
communicating, by a director computer via Y worker computer connections, such that Y≥2, to two or more worker computers, with at least one worker computer connection to each worker computer;
communicating, by the director computer via X assignment computer connections, such that X≥Y+2, to a group of one or more assignment computers;
communicating, by the director computer such that for each instruction received from each said assignment computer connection, the instruction including a specification of a set of elements to be tested to determine whether any element of the set satisfies a condition, including:
assigning the instruction to one said worker computer connection;
sending the instruction to the one said worker computer connection; and
if a response is received from the one said worker computer connection, the response including identification, if any, of the elements specified in the instruction that satisfies the condition, then sending the response to the assignment computer connection from which the instruction was received; and
if the response is not received from the one said worker computer connection, then indicating to the assignment computer connection from which the instruction was received that no response was received.

16. The process of claim 15, wherein the director computer is a first director computer, and further including Z connection layers, such that Z≥1, interposed between one said worker computer and the first director computer, and further comprising selecting, by the first director computer, one of two or more redundant director computers interposed at one said layer and sending the instruction to said one of two or more redundant director computers.

17. The process of claim 15, wherein:
at least some of said worker computers have a computational capacity characterized by a number of operations of a particular type performable within a time interval, and
at least some of said assignment computer connections have a computational capacity characterized by a number of operations of the same type that may be performed within a time interval, and
for at least one of said assignment computer connections, a sum of the computational capacity of the assignment computer connections is less than or equal to the computational capacity of the worker computer, and further comprising:
dividing, by the director computer, some of said instructions into portions, and assigning the portions based on said computational capacity.

18. The process of claim 15, further comprising:
receiving, by the director computer, two or more instructions from said assignment computer connections each with a respective set of said elements to be tested, and
forming, by the director computer, a second set of elements to be tested from a union of the sets of elements to be tested, and
sending, by the director computer, an other instruction to an other said worker computer connection to test the second set of elements, and
if a response is received from the worker computer connection that identifies one or more elements that satisfies the condition, determining, by the director computer, the set of which each identified element is a member and the instruction that corresponds to the set with the identified element, and sending, by the director computer, the response to the assignment computer connection from which the instruction that corresponds to the set with the identified element was received, and
for instructions for which a response is not sent that indicates an identity of one of the elements that satisfies the condition, indicating, by the director computer, to the assignment computer connection from which the instruction was received that no elements that satisfy the condition were identified.

19. The process of claim 15, wherein:
two or more said worker computer connections are each characterized by at least one type of computation, the two or more types of computation are specified in said two or more worker computer connections, and
further comprising:
receiving, by the director computer, one or more of said instructions from an assignment computer connection that specifies a type of computation required to test whether the element of the set satisfies the condition, assigning, by the director computer, the instruction that specifies the type of computation to one said worker computer connection that is characterized by the same type of computation as the type of computation specified in the instruction that instruction that specifies a type of computation, and
if none of the worker computer connections are characterized by the same type of computation that is the type of computation specified in the instruction, indicating, by the director computer, to the assignment computer connection from which the instruction that instruction that specifies the type of computation was received that the instruction cannot be performed.

20. The process of claim 15, wherein:
two or more said worker computer connections are each characterized by at least one computational resource, and
further comprising receiving, by the director computer, one or more said instructions from one said assignment computer connection that specifies a computational resource required to test whether an element of the set satisfies the condition, and
if the worker computer connections are characterized by a computational resource with equal or greater capacity than the computational resource specified in the instruction, then assigning, by the director computer, the instruction that specifies the computational resource to said worker computer connection that is characterized by a computational resource with equal or greater capacity than the computational resource specified in the instruction, and
if none of the worker computer connections are characterized by a computational resource with equal or greater capacity than the computational resource specified in the instruction, indicating, by the director computer, to the assignment computer connection from which the instruction was received that the instruction may not be performed.
